(19) United States
(12) Patent Application Publication
(10) Pub. No.: US 2022/0219441 A1
(43) Pub. Date: Jul. 14, 2022

(54) Enclosure Component Fabrication Facility

(71) Applicant: Build IP LLC, North Las Vegas, NV (US)

(72) Inventors: Paolo Tiramani, Las Vegas, NV (US); Galiano Tiramani, Las Vegas, NV (US); Kyle Denman, North Las Vegas, NV (US)

(21) Appl. No.: 17/552,108

(22) Filed: Dec. 15, 2021

Related U.S. Application Data
(63) Continuation-in-part of application No. 17/539,706, filed on Dec. 1, 2021.
Application No. 17/539,706 is a continuation-in-part of application No. PCT/US2021/059440, filed on Dec. 1, 2021.
Application No. 17/539,706 is a continuation-in-part of application No. 17/527,520, filed on Nov. 16, 2021.
Application No. 17/527,520 is a continuation of application No. PCT/US2021/059440, filed on Nov. 16, 2021.
Application No. 17/539,706 is a continuation of application No. PCT/US2021/061343, filed on Dec. 1, 2021.
Application No. PCT/US2021/061343 is a continuation-in-part of application No. PCT/US2021/059440, filed on Nov. 16, 2021.
Application No. PCT/US2021/059440 is a continuation-in-part of application No. 17/527,520, filed on Nov. 16, 2021.
Application No. 17/527,520 is a continuation-in-part of application No. 17/527,520, filed on Nov. 16, 2021.
Application No. 17/527,520 is a continuation of application No. PCT/US2021/059440, filed on Nov. 16, 2021.
Application No. PCT/US2021/059440 is a continuation-in-part of application No. 17/504,883, filed on Oct. 19, 2021.
(60) Provisional application No. 63/136,268, filed on Jan. 12, 2021.
(60) Provisional application No. 63/188,101, filed on May 13, 2021.
(60) Provisional application No. 63/136,268, filed on Jan. 12, 2021.
(60) Provisional application No. 63/188,101, filed on May 13, 2021.
(60) Provisional application No. 63/136,268, filed on Jan. 12, 2021.
(60) Provisional application No. 63/188,101, filed on May 13, 2021.
(60) Provisional application No. 63/136,268, filed on Jan. 12, 2021.
(60) Provisional application No. 63/188,101, filed on May 13, 2021.
(60) Provisional application No. 63/136,268, filed on Jan. 12, 2021.
(60) Provisional application No. 63/188,101, filed on May 13, 2021.
(60) Provisional application No. 63/136,268, filed on Jan. 12, 2021.
(60) Provisional application No. 63/188,101, filed on May 13, 2021.
(60) Provisional application No. 63/136,268, filed on Jan. 12, 2021.
(60) Provisional application No. 63/181,477, filed on Apr. 29, 2021.
(60) Provisional application No. 63/196,400, filed on Jun. 3, 2021.
(60) Provisional application No. 63/136,268, filed on Jan. 12, 2021.
(60) Provisional application No. 63/181,447, filed on Apr. 29, 2021.
(60) Provisional application No. 63/188,101, filed on May 13, 2021.
(60) Provisional application No. 63/196,400, filed on Jun. 3, 2021.

(51) Int. Cl. B32B 37/12; B32B 5/18; B32B 15/04; B32B 15/18; B32B 9/00; B32B 9/04; B32B 7/12; B32B 37/10; B32B 37/00; E04C 2/292

(52) U.S. Cl. CPC B32B 37/12; B32B 5/18; B32B 15/046; B32B 15/18; B32B 9/005; B32B 9/046; E04B 1/3445; B32B 37/1018; B32B 37/0046; E04C 2/292; B32B 2266/0228; B32B 2419/00; B32B 7/12

(57) ABSTRACT

A fabrication facility for manufacturing a laminate multi-layer enclosure component having a press table; a conveyor table adapted to move a plurality of superposed planar fabrication elements of a multi-layer enclosure component placed thereon into the press table; a first rotatable turntable proximate to a first side of the conveyor table, and a second rotatable turntable proximate to an opposed second side of the conveyor table. The first rotatable turntable is adapted to have positioned thereon plural stacks of planar fabrication elements and to move each of such plural stacks to a first access position on the first rotatable turntable; and the second rotatable turntable adapted to have positioned thereon plural stacks of planar fabrication elements and to move each of such plural stacks to a second access position on the second rotatable turntable. A movable adhesive spray gantry straddles the conveyor table.

### CROSS-REFERENCES TO RELATED APPLICATIONS

This application is a continuation-in-part application of U.S. Nonprovisional patent application Ser. No. 17/504,883, filed Oct. 19, 2021; and a continuation-in-part application of U.S. Nonprovisional patent application Ser. No. 17/527,520, filed Nov. 16, 2021; and a continuation-in-part application of U.S. Nonprovisional patent application Ser. No. 17/539,706, filed Dec. 1, 202; and this application claims the benefit of U.S. Provisional Patent Application No. 63/136,268, filed Jan. 12, 2021, U.S. Provisional Patent Application No. 63/181,447 filed Apr. 29, 2021, U.S. Provisional Patent Application No. 63/188,101, filed May 13, 2021 and U.S. Provisional Patent Application No. 63/196,400, filed Jun. 3, 2021. The contents of each of the above applications are incorporated by reference herein in their entirety.

### BACKGROUND OF THE INVENTION

### Field of the Invention

The inventions herein relate to structures, such as dwellings and other buildings for residential occupancy, commercial occupancy and/or material storage, and to components for such structures.

### Description of the Related Art

In the field of residential housing, the traditional technique for building homes is referred to as “stick-built” construction, where a builder constructs housing at the intended location using in substantial part raw materials such as wooden boards, plywood panels, and steel columns The materials are assembled piece by piece over a previously prepared portion of ground, for example, a poured concrete slab or a poured concrete or cinder block foundation.

There have been a variety of efforts to depart from the conventional construction techniques used to create dwellings, as well as commercial spaces and like. One of the alternatives to stick-built construction is very generally referred to as modular housing. As opposed to stick-built construction, where the structure is built on-site, a modular house is constructed in a factory and then shipped to the site, often by means of a tractor-trailer.

Such modular housing often exceeds in size normally-permitted legal limits for road transport. For example, in the United States the maximum permitted dimensions for road transport are in general 102 inches (259.1 cm) in width, 13.5 feet (4.11 m) in height and 65 to 75 feet (19.81 to 22.86 m) in length. Thus, in many cases transporting a modular house from factory to site requires oversize load permits, which may impose restrictions on when transport can be undertaken and what routes can be utilized. Oversize road regulations may also require the use of an escort car and a trailing car as well. All of these requirements and restrictions inevitably increase the cost of the modular housing.

Significant advancements in the construction of dwellings and commercial space are described in U.S. Pat. Nos. 8,474,194, 8,733,029, 10,688,906, 10,829,029 and 10,926,689. In one aspect, these patents pertain to fabricating wall, floor and roof components in a factory that are folded together into a compact shipping module, and which are then transported to the intended location and unfolded to yield a fully formed structure.

### SUMMARY OF THE INVENTION

The present inventions constitute advancements in the facilities used to fabricate the wall, floor and roof components of foldable transportable building structures.

In one aspect, the present inventions are directed to a fabrication facility for manufacturing a laminate multi-layer enclosure component comprising a press table, a conveyor table adapted to move a plurality of superposed panels and/or sheets of a multi-layer enclosure component placed thereon into the press table, a first rotatable turntable proximate to a first side of the conveyor table, and a second rotatable turntable proximate to an opposed second side of the conveyor table. The first rotatable turntable is adapted to have positioned thereon plural stacks of planar fabrication elements and to move each of such plural stacks to a first access position on the first rotatable turntable proximate to the first side of the conveyor table, and the second rotatable turntable is adapted to have positioned thereon plural stacks of planar fabrication elements and to move each of such plural stacks to a second access position on the second rotatable turntable proximate to the second side of the conveyor table. There is also provided a movable adhesive spray gantry straddling the conveyor table.

In another aspect, the present inventions are directed to a method of manufacturing an enclosure component having a laminate multi-layer design utilizing a conveyor table and one or more rotatable turntables, where each turntable is adapted to have positioned thereon, and has positioned thereon, plural stacks of planar fabrication elements, and where each turntable is further adapted to rotate to move each of the plural stacks positioned thereon to an access position proximate to the conveyor table. The method comprises moving to the conveyor table a first planar fabrication element from a first of the plural stacks of planar fabrication elements located at the access position on the first rotatable turntable; rotating the first rotatable turntable, to position at the access position of the first rotatable turntable a second of the plural stacks of planar fabrication elements positioned on the first rotatable turntable; and moving to the conveyor table a second planar fabrication element from the second of the plural stacks of planar fabrication elements positioned at the access position of the first rotatable turntable.

These and other aspects of the present inventions are described in the drawings annexed hereto, and in the description of the preferred embodiments and claims set forth below.

### BRIEF DESCRIPTION OF THE DRAWINGS

FIG. 1 is a perspective view of finished structures prepared in accordance with the present inventions.

FIG. 2 is a top schematic view of a finished structure prepared in accordance with the present inventions.

FIG. 3 is an end view of a shipping module from which is formed the finished structure respectively shown in FIG. 1.

FIGS. 4 and 5 are partial cutaway views of a finished structure in accordance with the present inventions, depicting in greater detail aspects of the roof and floor components.

FIG. 6 is a schematic perspective view depicting the exterior edge reinforcement for a wall component in accordance with the present inventions.

FIG. 7 is an exploded cross-sectional view of a multi-layered, laminate construction for use in the enclosure components of the present inventions.

FIGS. 8A is a perspective view of a foldable I-beam for a floor component in accordance with the present inventions, in the beam unfolded position, and FIG. 8B is a side view of a foldable I-beam for a floor component in accordance with the present inventions, in the beam folded position.

FIG. 9 is a cutaway perspective view showing the placement of a foldable I-beam and floor end hinge assemblies in the structure of a floor component in accordance with the present inventions.

FIGS. 10A is a perspective view of a foldable I-beam for a roof component in accordance with the present inventions, in the beam unfolded position, and FIG. 10B is a side view of a foldable I-beam for a roof component in accordance with the present inventions, in the beam folded position.

FIG. 11 is a cutaway perspective view showing the placement of a foldable I-beam and roof end hinge assemblies in the structure of a roof component in accordance with the present inventions.

FIG. 12A is a perspective view of a rectangular roof component containing two foldable I-beam assemblies in accordance with the present inventions, and FIG. 12B is a perspective view of a rectangular roof component containing N-1 foldable I-beam assemblies in accordance with the present inventions.

FIG. 13 is a perspective view of an enclosure component fabrication facility in accordance with the present inventions.

FIGS. 14A-14J are depictions at different times of the fabrication of an exemplary wall component utilizing the enclosure component fabrication facility shown in FIG. 13 in accordance with the present inventions.

### DETAILED DESCRIPTION OF THE PREFERRED EMBODIMENTS

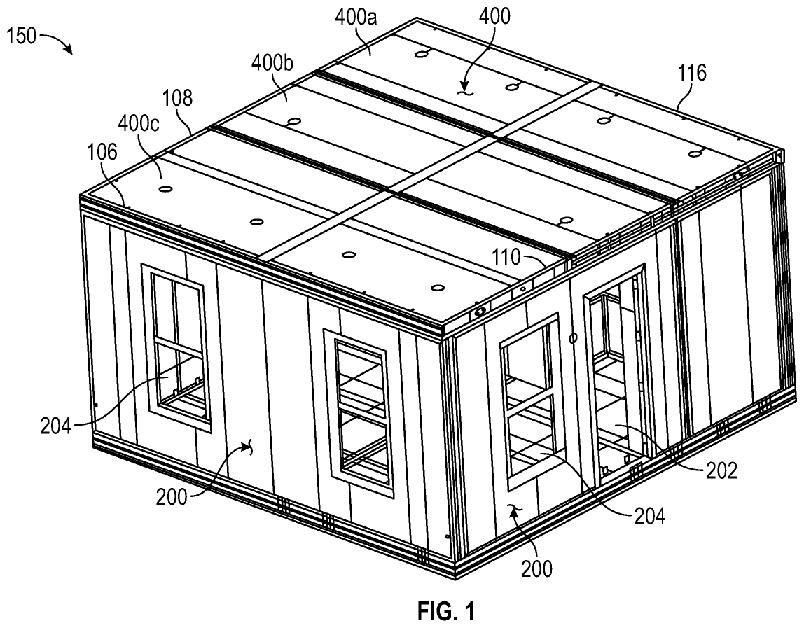

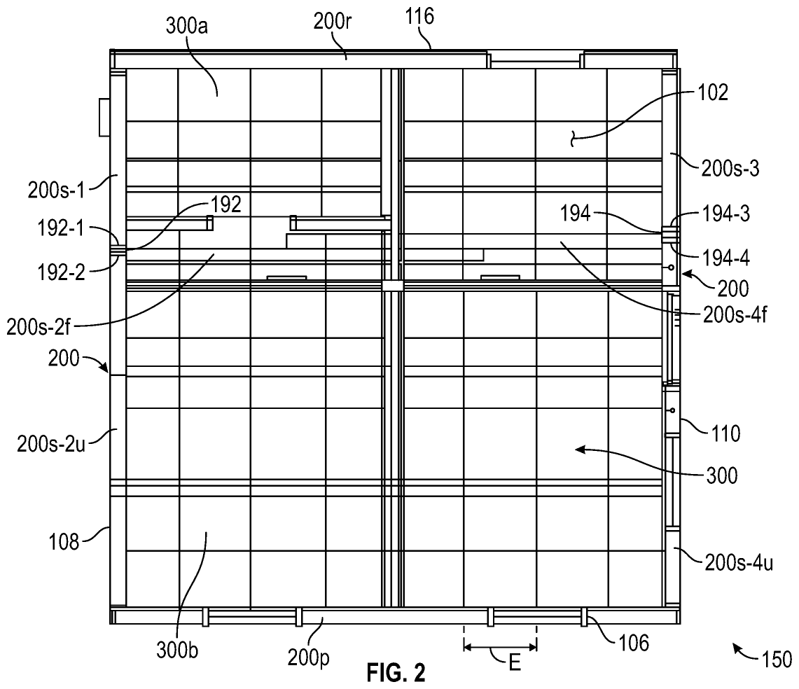

An embodiment of the foldable, transportable structure 150 in which the inventions disclosed herein can be implemented is depicted in FIGS. 1 through 5. When fully unfolded, as exemplified by FIG. 1, structure 150 has a rectangular shape made of three types of generally planar and rectangular enclosure components 155, the three types of enclosure components 155 consisting of a wall component 200, a floor component 300, and a roof component 400. As shown in FIGS. 1 and 2, the perimeter of structure 150 is defined by first longitudinal edge 106, first transverse edge 108, second longitudinal edge 116 and second transverse edge 110. For convenience, a direction parallel to first longitudinal edge 106 and second longitudinal edge 116 may be referred to as the “longitudinal” direction, a direction parallel to first transverse edge 108 and second transverse edge 110 may be referred to as the “transverse” direction, and a direction parallel to the vertical direction in FIG. 1 may be referred to as the “vertical” direction. Structure 150 as shown has one floor component 300, one roof component 400 and four wall components 200; although it should be understood that the present inventions are applicable to structures having other configurations as well.

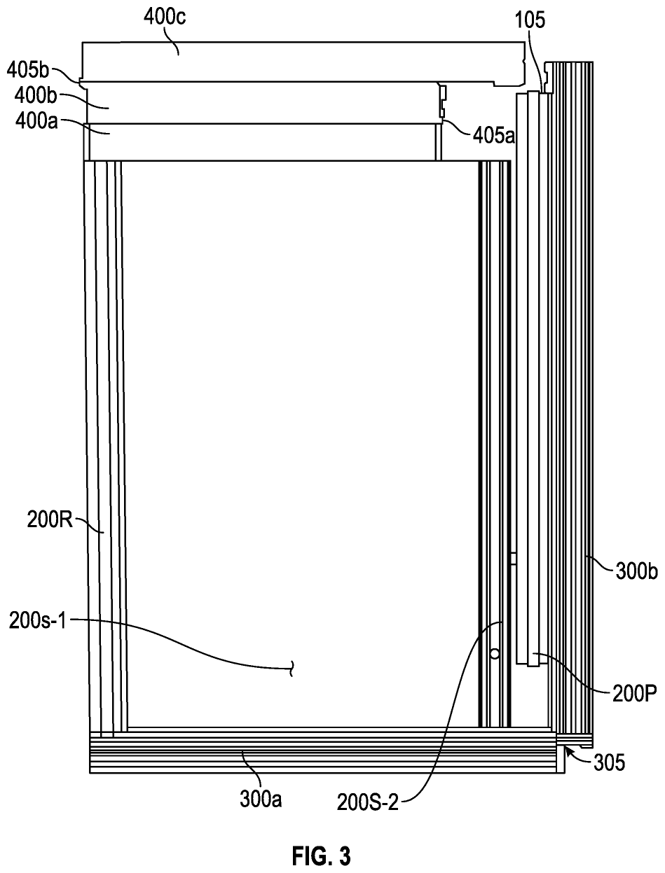

Enclosure components 155 (wall component 200, floor component 300 and roof component 400) can be fabricated and dimensioned as described herein and positioned together to form a shipping module 100, shown end-on in FIG. 3. The enclosure components 155 are dimensioned so that the shipping module 100 is within U.S. federal highway dimensional restrictions. As a result, shipping module 100 can be transported over a limited access highway more easily, and with appropriate trailering equipment, transported without the need for oversize permits. Thus, the basic components of structure 150 can be manufactured in a factory, positioned together to form the shipping module 100, and the modules 100 can be transported to the desired site for the structure, where they can be readily assembled, as described herein.

### Enclosure Component (155): General Description

The enclosure components 155 of the present invention include a number of shared design features that are described below.

A. Laminate Structure Design

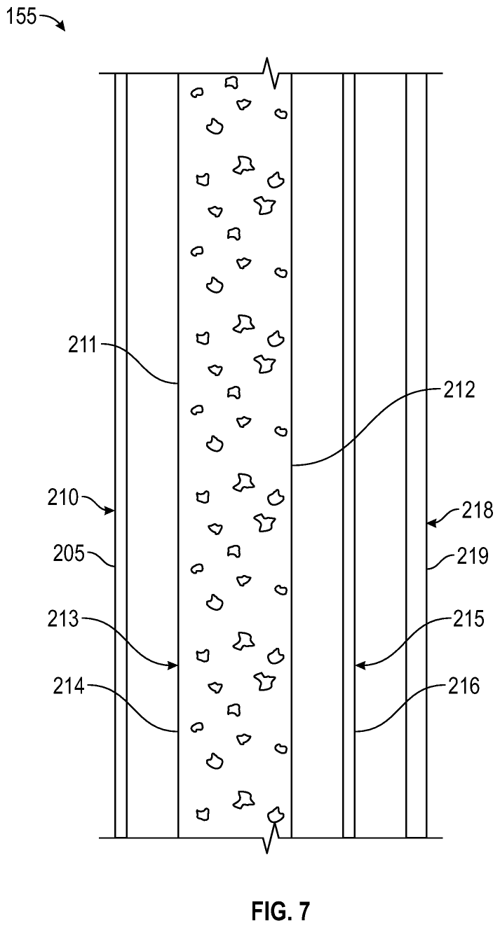

Enclosure components 155 can be fabricated using a multi-layered, laminate design. A particular laminate design that can be used to fabricate enclosure components 155 comprises a first structural layer 210, a foam panel layer 213, a second structural layer 215 and a protective layer 218, as shown in FIG. 7 and described further below.

In particular, first structural layer 210 is provided in the embodiment of enclosure component 155 that is depicted in FIG. 7. First structural layer 210 in the embodiment shown comprises a sheet metal layer 205, which can be for example galvanized steel or aluminum. Sheet metal layer 205 is made from a plurality of generally planar rectangular metal sheets 206 positioned adjacent to each other to generally cover the full area of the intended enclosure component 155.

Referring again to FIG. 7, there is next provided in the depicted embodiment of enclosure component 155 a foam panel layer 213, comprising a plurality of generally planar rectangular foam panels 214 collectively presenting a first face and an opposing second face. Foam panels 214 are made for example of expanded polystyrene (EPS) foam. A number of these foam panels 214 are positioned adjacent to each other and superposed first face-down on first structural layer 210 to generally cover the full area of the intended enclosure component 155. The foam panels 214 of foam panel layer 213 preferably are fastened to the metal sheets 206 of first structural layer 210 using a suitable adhesive, preferably a polyurethane based construction adhesive. Foam panel layer 213 can include exterior edge reinforcement and interior edge reinforcement, as described further below

In the embodiment of the enclosure component 155 depicted in FIG. 7, there is next provided a second structural layer 215, having a first face that is positioned on the opposing second face of foam panels 214 (the face distal from first structural layer 210), and also having a second opposing face. Second structural layer 215 in the embodiment shown comprises a sheet metal layer 216, which can be for example galvanized steel or aluminum. Sheet metal layer 216 is made from a plurality of generally planar rectangular metal sheets 217 positioned adjacent to each other and superposed first face-down on the second opposing face of foam panel layer 213 to generally cover the full area of the intended enclosure component 155. The metal sheets 217 of second structural layer 215 preferably are fastened to foam panel layer 213 using a suitable adhesive, preferably a polyurethane based construction adhesive.

In the embodiment of the enclosure component 155 depicted in FIG. 7, there is optionally next provided a protective layer 218, having a first face that is positioned on the second opposing face of second structural layer 215 (the face distal from foam panel layer 213), and also having a second opposing face. Optional protective layer 218 in the embodiment shown comprises a plurality of rectangular structural building panels 219 principally comprising an inorganic composition of relatively high strength, such as magnesium oxide (MgO). The structural building panels 219 are positioned adjacent to each other and superposed first face-down on the second opposing face of second structural layer 215 to generally cover the full area of the intended enclosure component 155. The building panels 219 of protective layer 218 preferably are fastened to second structural layer 215 using a suitable adhesive, preferably a polyurethane based construction adhesive. Protective layer 218 can be used if desired to impart a degree of fire resistance to the enclosure component 155, as well as to provide a pleasing texture and/or feel.

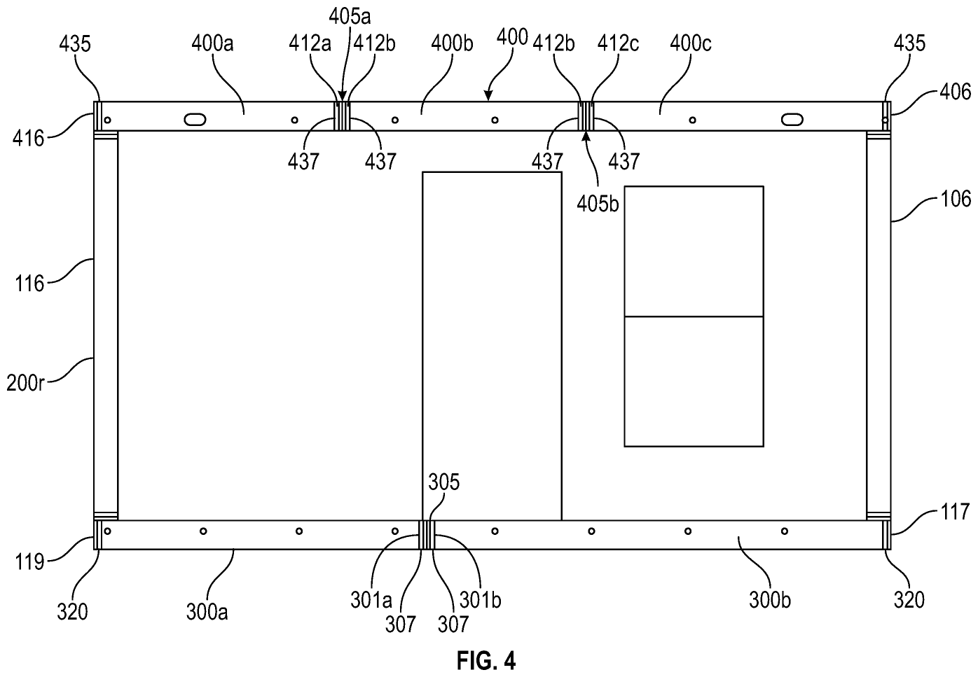

In this disclosure, the sheets 206, 217 and panels 214, 219 used to fabricate layers 210, 213, 215 and 218 are generically referred to as “planar fabrication elements.” Other embodiments of multi-layered, laminate designs, which can be used to fabricate the enclosure components 155 of the present invention, are described in U.S. Nonprovisional patent application Ser. No. 16/786,130, entitled “Foldable Building Structures with Utility Channels and Laminate Enclosures,” filed on Feb. 10, 2020 and now issued as U.S. Pat. No. 11,118,344. The contents of that U.S. Nonprovisional patent application Ser. No. 16/786,130, entitled “Foldable Building Structures with Utility Channels and Laminate Enclosures” and filed on Feb. 10, 2020 are incorporated by reference as if fully set forth herein, particularly including the multi-layered, laminate designs described for example at ¶¶ 0034-57 and depicted in FIGS. 4A-4D thereof.

B. Enclosure Component Exterior Edge Reinforcement

The exterior edges of each enclosure component 155 (i.e., the edges that define the perimeter of enclosure component 155) can be provided with exterior edge reinforcement, as desired. Exterior edge reinforcement generally comprises an elongate rigid member which can protect the foam panel material of foam panel layer 213 that would otherwise be exposed at the exterior edges of enclosure components 155. Exterior edge reinforcement can be fabricated from one or more of laminated strand lumber board, wooden board, C-channel extruded aluminum or steel, or the like, and is generally secured to the exterior edges of enclosure component 155 with fasteners, such as screw or nail fasteners, and/or adhesive.

C. Enclosure Component Partitioning

Enclosure components 155 in certain instances are partitioned into enclosure component portions to facilitate forming a compact shipping module 100. In those instances where an enclosure component 155 is partitioned into enclosure component portions, any exterior edge reinforcement on the exterior edges defining the perimeter of the enclosure component is segmented as necessary between or among the portions.

The enclosure component portions can be joined by hinge structures or mechanisms to permit the enclosure component portions to be “folded” and thereby contribute to forming a compact shipping module 100.

D. Enclosure Component Interior Edge Reinforcement

An enclosure component 155 partitioned into enclosure component portions will have interior edges. There will be two adjacent interior edges for each adjacent pair of enclosure component portions. Such interior edges can be provided with interior edge reinforcement. Similar to exterior edge reinforcement, such interior edge reinforcement generally comprises an elongate, rigid member which can protect the foam panel material of foam panel layer 213 which that would otherwise be exposed at the interior edges of enclosure components 155. Interior edge reinforcement can be fabricated from one or more of laminated strand lumber board, wooden board, C-channel extruded aluminum or steel, or the like, and is generally secured to the interior edges of enclosure component 155 with fasteners, such as screw or nail fasteners, and/or adhesive.

E. Enclosure Component Load Transfer

In the case of enclosure components 155, it is necessary to transfer the loads imposed on their surfaces to their exterior edges, where those loads can be transferred either to or through adjoining walls, or to the building foundation. For enclosure components 155 that are horizontally oriented when in use (floor component 300 and roof component 400), such loads include the weight of equipment, furniture and people borne by their surfaces, as well as vertical seismic loads. For enclosure components that are vertically oriented when in use (wall component 200), such loads include those arising from meteorological conditions (hurricanes, tornadoes, etc.) and human action (vehicle and other object impacts).

For this purpose, multi-layered, laminate designs as shown in FIG. 7 will function to transfer the loads described above. To add additional load transfer capability, structural members, such as beams and/or joists, can be utilized within the perimeter of the enclosure components 155, as is deemed appropriate to the specific design of structure 150 and the particular enclosure component 155, to assist in the transfer of loads to the exterior edges. Particular beam assemblies for floor component 300 and roof component 400 are described below.

F. Enclosure Component Sealing Systems

Structure 150 comprises a number of wall, floor and roof components with abutting or exposed exterior edges, as well as a number of partitioned wall, floor and roof components with interior edges. In this regard, sealing structures can be utilized, with the objective to limit or prevent the ingress of rain, water, noise and outside air across these exterior and interior edges into the interior of structure 150.

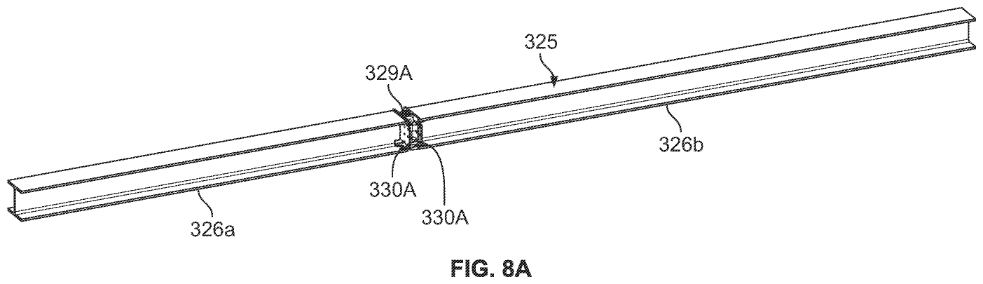

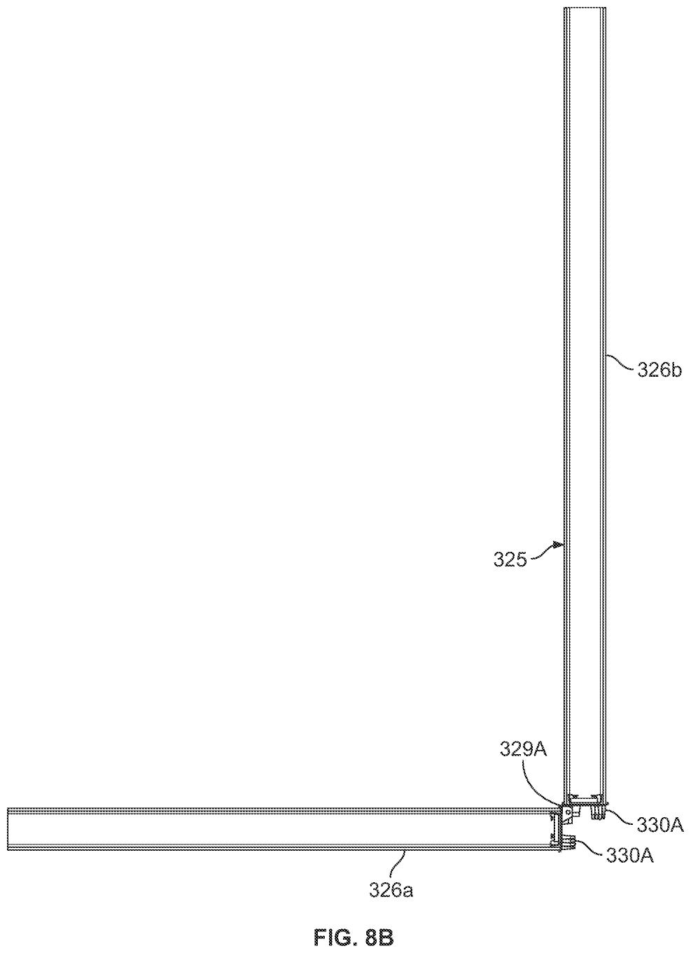

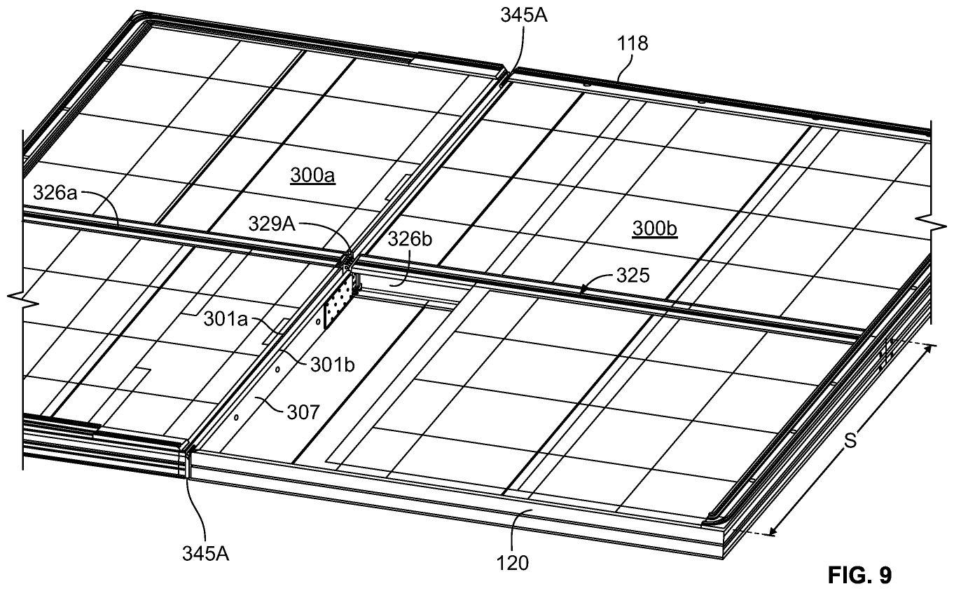

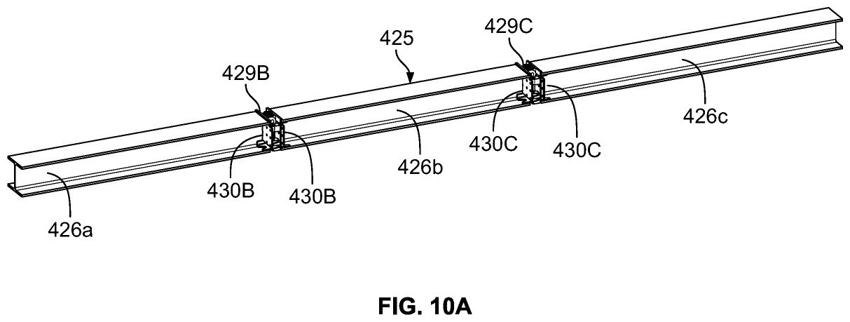

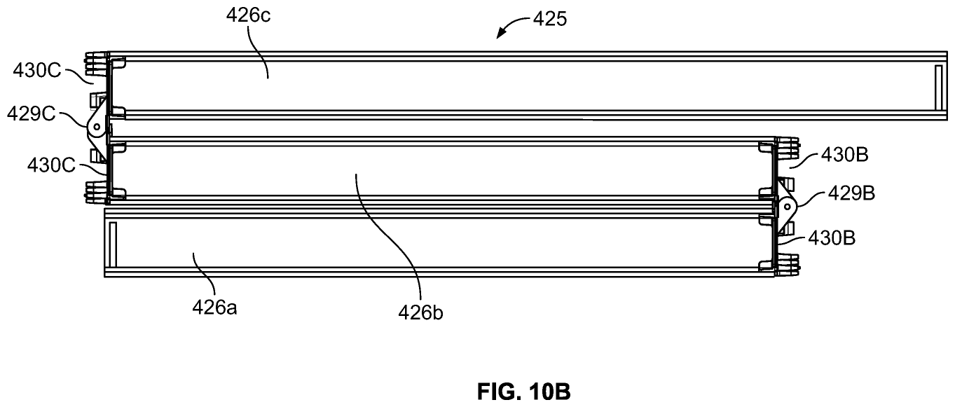

Particular sealing structures for accomplishing the foregoing objective are described in U.S. Nonprovisional patent application Ser. No. 17/504,883, filed on Oct. 19, 2021, entitled “Sheet/Panel Design for Enclosure Component Manufacture” and having the same inventors as the present application, and in PCT Patent Application No. PCT/US21/56415, entitled “Enclosure Component Sealing Systems,” filed on Oct. 25, 2021 and having the same inventors as the present application. The contents of that U.S. Nonprovisional patent application Ser. No. 17/504,883, filed on Oct. 19, 2021, entitled “Sheet/Panel Design for Enclosure Component Manufacture” and having the same inventors as the present application, are hereby incorporated by reference as if fully set forth herein, particularly including the sealing systems described for example at ¶¶ 0083-0170 and depicted in FIGS. 10-20 thereof, and also including the exemplary placements for such sealing systems described in ¶¶ 0171-0177 and depicted in FIGS. 21A-21B thereof. The contents of that PCT Patent Application No. PCT/US21/56415, entitled “Enclosure Component Sealing Systems,” filed on Oct. 25, 2021 and having the same inventors as the present application, are also incorporated by reference as if fully set forth herein, particularly including the sealing systems described for example at ¶¶ 0080-0167 and depicted in FIGS. 9-20 thereof, and also including the exemplary placements for such sealing systems described in ¶¶ 0168-0174 and depicted in FIGS. 8A-8B thereof.

Further design details of wall component 200, floor component 300, and roof component 400 are provided in the sections following.

### Wall Component (200)

Typically, a structure 150 will utilize four wall components 200, with each wall component 200 corresponding to an entire wall of structure 150.

A. General Description

Wall component 200 has a generally rectangular perimeter. As shown in FIG. 1, wall components 200 have plural apertures, specifically a door aperture 202, which has a door frame and door assembly, and plural window apertures 204, each of which has a window frame and a window assembly. The height and length of wall components 200 can vary in accordance with design preference, subject as desired to the various considerations described in this disclosure. In this disclosure, structure 150 is fashioned with all sides of equal length; accordingly, its first and second longitudinal edges 106 and 116, and its first and second transverse edges 108 and 110, are all of equal length. It should be understood however, that the inventions described herein are applicable to structures having other dimensions, such as where two opposing wall components 200 are longer than the other two opposing wall components 200.

As indicated above, wall components 200 of the present inventions can utilize a multi-layered, laminate design. In the embodiment depicted in FIGS. 1 through 6, wall component 200 utilizes the multi-layered, laminate design shown in FIG. 7 employing these particular elements: sheet metal layer 205 of first structural layer 210 is 24 gauge galvanized steel approximately 0.022-0.028 inch thick, the foam panels 214 of foam panel layer 213 are EPS foam approximately 5.68 inches thick, the sheet metal layer 216 of second structural layer 215 is 24 gauge galvanized steel approximately 0.022-0.028 inch thick, and the building panels 219 of protective layer 218 are MgO board approximately 0.25 inch (6 mm) thick.

The perimeter of each wall component 200 is generally provided with exterior edge reinforcement. As exemplified by wall component 200 shown in FIG. 6, the exterior edge reinforcement for wall component 200 is a floor plate 220 along the bottom horizontal edge, a ceiling plate 240 along the top horizontal edge and two end pieces 270 respectively fastened at each vertical edge of wall component 200. In the case of a wall component 200, exterior edge reinforcement provides regions for fastening like regions of abutting wall components 200, roof component 400 and floor component 300, in addition to protecting the exterior edges of foam panel material. In the embodiment shown in FIGS. 1 through 6, the exterior edge reinforcement for wall component 200 provided by floor plate 220, ceiling plate 240, and end pieces 270 is fabricated from laminated strand lumber board 5.625″ deep and 1.5″ thick.

B. Partitioned Wall Components

Referring to FIG. 2, structure 150 has two opposing wall components 200, where one of the two opposing wall components 200 comprises first wall portion 200s-1 and second wall portion 200s-2, and the other of the two opposing wall components 200 comprises third wall portion 200s-3 and fourth wall portion 200s-4. Each of wall portions 200s-1, 200s-2, 200s-3 and 200s-4 has a generally rectangular planar structure. As shown in FIG. 2, the interior vertical edge 192-1 of wall portion 200s-1 is proximate to a respective interior vertical edge 192-2 of wall portion 200s-2, and the interior vertical edge 194-3 of wall portion 200s-3 is proximate a respective interior vertical wall edge 194-4 of wall portion 200s-4. Interior edge reinforcement can be provided at any one or more of vertical edges 192-1, 192-2, 194-3 and 194-4. In the embodiment shown in FIGS. 1 through 6, the interior edge reinforcement provided at vertical edges 192-1, 192-2, 194-3 and 194-4, is fabricated from laminated strand lumber board 5.625″ deep and 1.5″ thick.

Referring again to FIG. 2, first wall portion 200s-1 is fixed in position on floor portion 300a proximate to first transverse edge 108, and third wall portion 200s-3 is fixed in position on floor portion 300a, opposite first wall portion 200s-1 and proximate to second transverse edge 110. First wall portion 200s-1 is joined to second wall portion 200s-2 with a hinge structure that permits wall portion 200s-2 to pivot about vertical axis 192 between a folded position and an unfolded position, and third wall portion 200s-3 is joined to fourth wall portion 200s-4 with a hinge structure to permit fourth wall portion 200s-4 to pivot about vertical axis 194 between a folded position and an unfolded position.

Notably, first wall portion 200s-1 is longer than third wall portion 200s-3 by a distance approximately equal to the thickness of wall component 200, and second wall portion 200s-2 is shorter than third wall portion 200s-3 by a distance approximately equal to the thickness of wall component 200. Furthermore, wall portion 200s-1 and wall portion 200s-3 are each shorter in length (the dimension in the transverse direction) than the dimension of floor portion 300a in the transverse direction. Dimensioning the lengths of wall portions 200s-1, 200s-2, 200s-3 and 200s-4 in this manner permits wall portions 200s-2 and 200s-4 to nest against each other in an overlapping relationship when in an inwardly folded position. In this regard, FIG. 2 depicts wall portions 200s-2 and 200s-4 both in their unfolded positions, where they are labelled 200s-2u and 200s4-u respectively, and FIG. 2 also depicts wall portions 200s-2 and 200s-4 both in their inwardly folded positions, where they are labelled 200s-2f and 200s4-f respectively. When wall portions 200s-2 and 200s-4 are in their inwardly folded positions (200s-2f and 200s-4f), they facilitate forming a compact shipping module. When wall portion 200s-2 is in its unfolded position (200s-2u), it forms with wall portion 200s-1 a wall component 200 proximate first transverse edge 108, and when wall portion 200s-4 is in its unfolded position (200s-4u), it forms with wall portion 200s-3 a wall component 200 proximate second transverse edge 110.

The hinge structures referenced above, for securing first wall portion 200s-1 to second wall portion 200s-2, and third wall portion 200s-3 to fourth wall portion 200s-4, can be surface mounted or recessed, and of a temporary or permanent nature. The provision of interior edge reinforcement, as described above, can provide a region for securing such hinge structures. Suitable hinge structures can be fabricated for example of ferrous or non-ferrous metal, plastic or leather material.

C. Unpartitioned Wall Components

As compared to the two wall components 200 proximate first and second transverse edges 108 and 110, which are partitioned into wall portions, the remaining two wall components 200 proximate first and second longitudinal edges 106 and 116 do not comprise plural wall portions, but rather each is a single piece structure. However, one of these wall components 200, which is sometimes denominated 200P in this disclosure, and which is located on floor portion 300b proximate first longitudinal edge 106, is pivotally secured to floor portion 300b by means of hinge structures to permit wall component 200P to pivot about horizontal axis 105 shown in FIG. 3 from a folded position to an unfolded position. Pivotally securing wall component 200P also facilitates forming a compact shipping module 100. The remaining wall component 200, sometimes denominated 200R in this disclosure, is rigidly secured on floor portion 300a proximate second longitudinal edge 116 and abutting the vertical edges of first wall portion 200s-1 and third wall portion 200s-3 proximate to second longitudinal edge 116, as shown in FIG. 2.

The hinge structures referenced above, for securing wall component 200P to floor portion 300b, can be surface mounted or recessed, and of a temporary or permanent nature. The provision of exterior edge reinforcement, as described above, can provide a region for securing such hinge structures. Suitable hinge structures can be fabricated for example of ferrous or non-ferrous metal, plastic or leather material.

### Floor Component (300)

Typically, a structure 150 will utilize one floor component 300; thus floor component 300 generally is the full floor of structure 150.

A. General Description

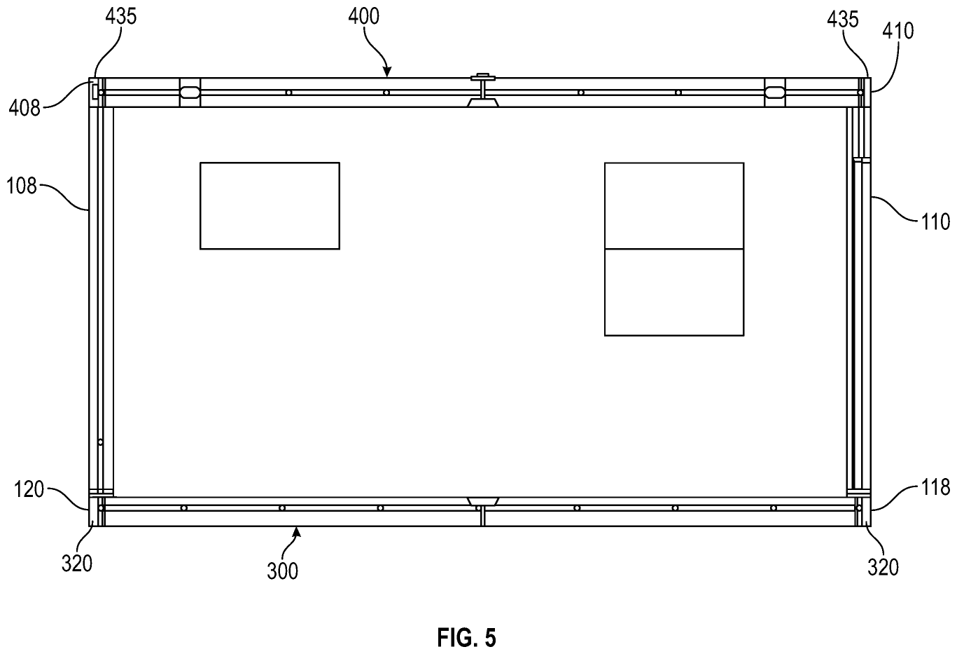

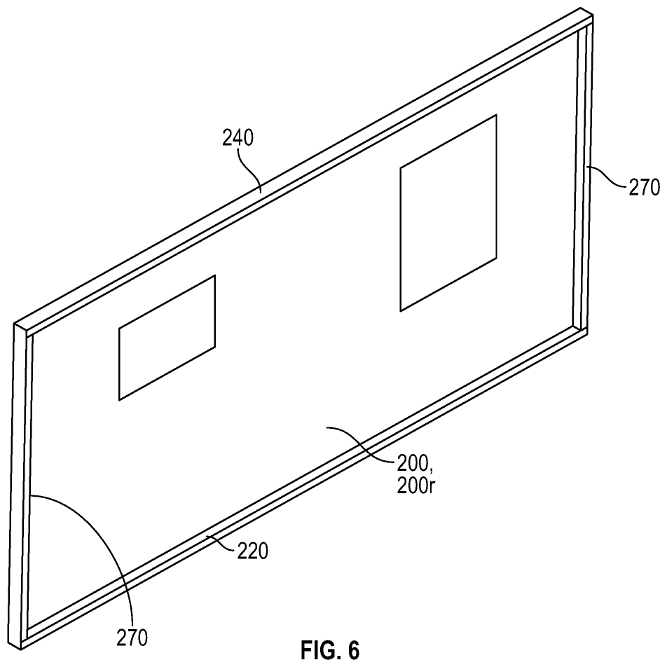

Floor component 300 has a generally rectangular perimeter. FIGS. 4 and 5 depict floor component 300 in accordance with the present inventions. The perimeter of floor component 300 is defined by first longitudinal floor edge 117, first transverse floor edge 120, second longitudinal floor edge 119 and second transverse floor edge 118. In particular, (a) first longitudinal floor edge 117, (b) first transverse floor edge 120, (c) second longitudinal floor edge 119 and (d) second transverse floor edge 118 generally coincide with (i.e., underlie) (w) first longitudinal edge 106, (x) first transverse edge 108, (y) second longitudinal edge 116 and (z) second transverse edge 110, respectively, of structure 150.

The length and width of floor component 300 can vary in accordance with design preference, subject as desired to the various considerations described in this disclosure. In the particular embodiment of structure 150 depicted in FIGS. 2, 4 and 5, floor component 300 is approximately 19 feet (5.79 m) by 19 feet (5.79 m).

Floor component 300 and its constituent elements are generally designed and dimensioned in thickness and in other respects to accommodate the particular loads to which floor component 300 may be subject. It is preferred that floor component 300 utilize a multi-layered, laminate design, such as that described in connection with FIG. 7. In the embodiment shown in FIGS. 4 and 5, the bottom-most surface of floor component 300 comprises sheet metal layer 205 of first structural layer 210, with sheet metal layer 205 being 24 gauge galvanized steel approximately 0.022-0.028 inch thick. Above sheet metal layer 205 there are provided foam panels 214 of foam panel layer 213. In the embodiment shown in FIGS. 4 and 5, foam panels 214 are EPS foam approximately 7.125 inches thick. Above foam panel layer 213 there is provided sheet metal layer 216 of second structural layer 215, with sheet metal layer 216 being 24 gauge galvanized steel approximately 0.022-0.028 inch thick. Above sheet metal layer 216 of second structural layer 215, there are provided building panels 219 of protective layer 218, with building panels 219 being MgO board approximately 0.25 inch (6 mm) thick.

The perimeter of each floor component 300 is generally provided with exterior edge reinforcement. As exterior edge reinforcement for the embodiments of floor component 300 shown in FIGS. 4 and 5, a first footing beam 320 (visible edge-on in FIG. 4) is positioned at the first longitudinal floor edge 117 of floor component 300, a second footing beam 320 (visible edge-on in FIG. 5) is positioned at the second transverse floor edge 118 of floor component 300, a third footing beam 320 (visible edge-on in FIG. 5) is positioned at the first transverse floor edge 120 of floor component 300, and a fourth footing beam 320 (visible edge-on in FIG. 4) is positioned at the second longitudinal floor edge 119 of floor component 300. In the case of floor component 300, the exterior edge reinforcement provided by footing beams 320 assists in resisting vertical loads and transferring such loads to any roof component 400 thereunder and then to underlying wall components 200, and/or to the foundation of the finished structure 150, in addition to protecting the edges of foam panel material of the foam panel layer 213. In the embodiment shown in FIGS. 1 through 6, the exterior edge reinforcement provided by footing beams 420 of floor component 300 is fabricated from laminated strand lumber board 7.125″ deep and 1.5″ thick.

B. Floor Partitioning

The floor component 300 is partitioned into floor portion 300a and floor portion 300b. FIG. 2 shows flow portions 300a and 300b in plan view, and FIG. 4 shows floor portions 300a and 300b in section view, edge-on.

Each of the floor portions 300a and 300b is a planar generally rectangular structure, with floor portion 300a adjoining floor portion 300b. Interior edge 301a of floor portion 300a abuts interior edge 301b of floor portion 300b, as shown in FIG. 4. As interior edge reinforcement, a reinforcing board 307 is positioned in floor portion 300a adjacent interior edge 301a, and a reinforcing board is positioned in floor portion 300b adjacent interior edge 301b. In the embodiment shown in FIGS. 1 through 6, the interior edge reinforcement provided by reinforcing boards 307 is laminated strand lumber board 7.125″ deep and 1.5″ thick.

Referring to structure 150 shown in FIGS. 2 and 4, floor portion 300a is fixed in position relative to first wall portion 200s-1, third wall portion 200s-3 and wall component 200s-R. Floor portion 300a is joined with hinge structures to floor portion 300b, so as to permit floor portion 300b to pivot through approximately ninety degrees)(90° of arc about a horizontal axis 305, located proximate the top surface of floor component 300, between a fully folded position, where floor portion 300b is vertically oriented as shown in FIG. 3, and a fully unfolded position, shown in FIGS. 2 and 4, where floor portion 300b is horizontally oriented and co-planar with floor portion 300a. Particular embodiments of suitable hinge structures for joining floor portion 300a to floor portion 300b are described below.

C. Hinged Vertical Load Transfer Components

FIG. 8A shows a beam assembly 325 that can be placed within floor component 300 to provide reinforcement in the direction along the beam and assist in transferring vertical loads borne by floor component 300 to its edges. Beam assembly 325 includes two I-beams 326a and 326b. I-beam 326a is positioned approximately in the middle of floor portion 300a, I-beam 326b is positioned approximately in the middle of floor portion 300b, and each of I-beams 326a and 326b is oriented in the transverse direction. A hinge assembly 329A joins I-beam 326a to I-beam 326b. The hinge assembly 329A permits beam assembly 325 to be folded to a beam folded position shown in FIG. 8B and unfolded to a beam unfolded position shown in FIG. 8A. Further, the hinge assembly 329A can be locked when beam assembly 325 is in the beam unfolded position, which transforms beam assembly 325 into a rigid structure that will reinforce floor component 300 in the direction perpendicular to its axis of folding.

Hinge assembly 329A comprises two identical hinge assembly portions 330A partnered together to form a pivoted junction, as shown in FIGS. 8A and 8B. A detailed description of the construction of hinge assembly 329A and its hinge assembly portions 330A is set forth in U.S. Nonprovisional patent application Ser. No. 17/527,520 entitled “Folding Beam Systems”, filed Nov. 16, 2021 and having the same inventors as the subject application. The contents of that U.S. Nonprovisional patent application Ser. No. 17/527,520 entitled “Folding Beam Systems”, filed Nov. 16, 2021 and having the same inventors as the subject application, is incorporated by reference as if fully set forth herein, particularly the description of the construction of hinge assembly 329A and its hinge assembly portions 330A set forth for example in ¶¶ 0075-0087 and in FIGS. 9-12 and 13C-13E thereof.

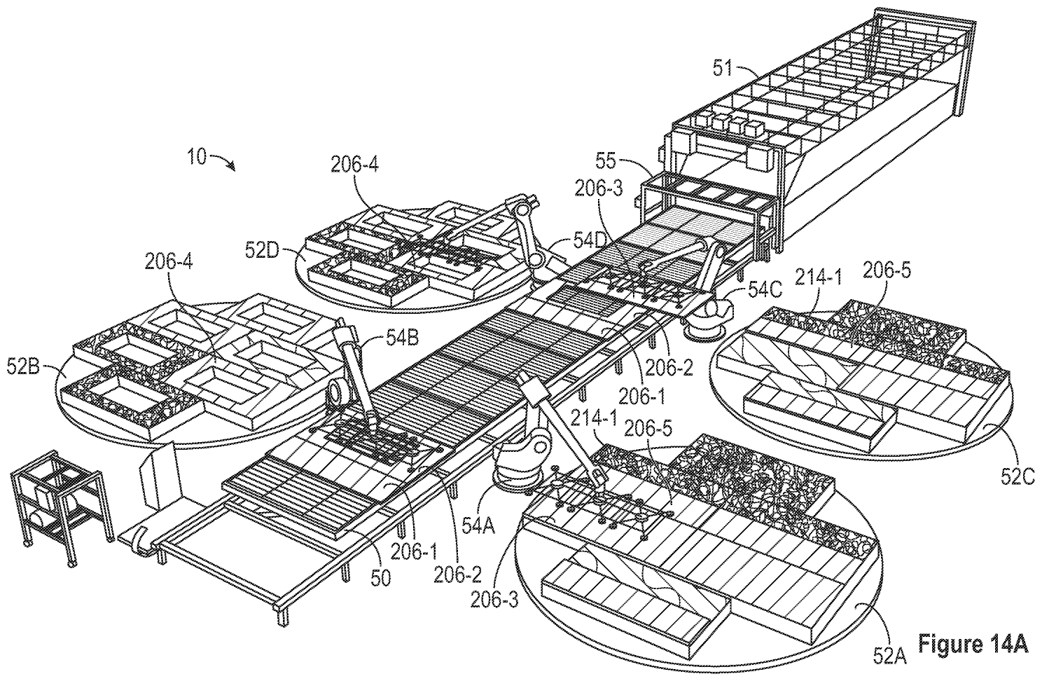

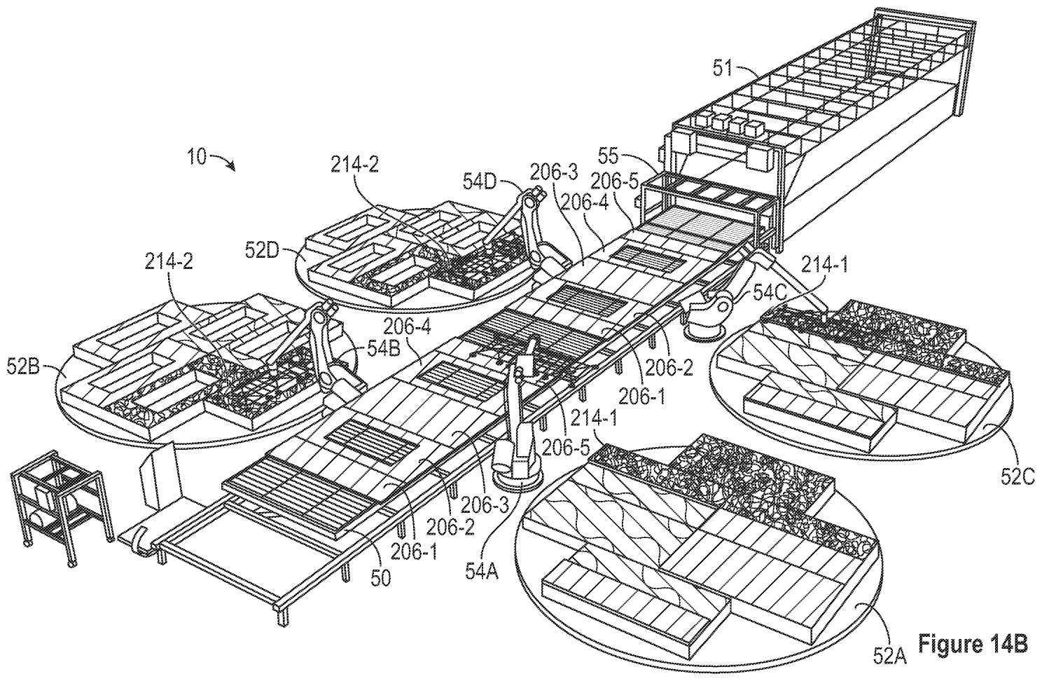

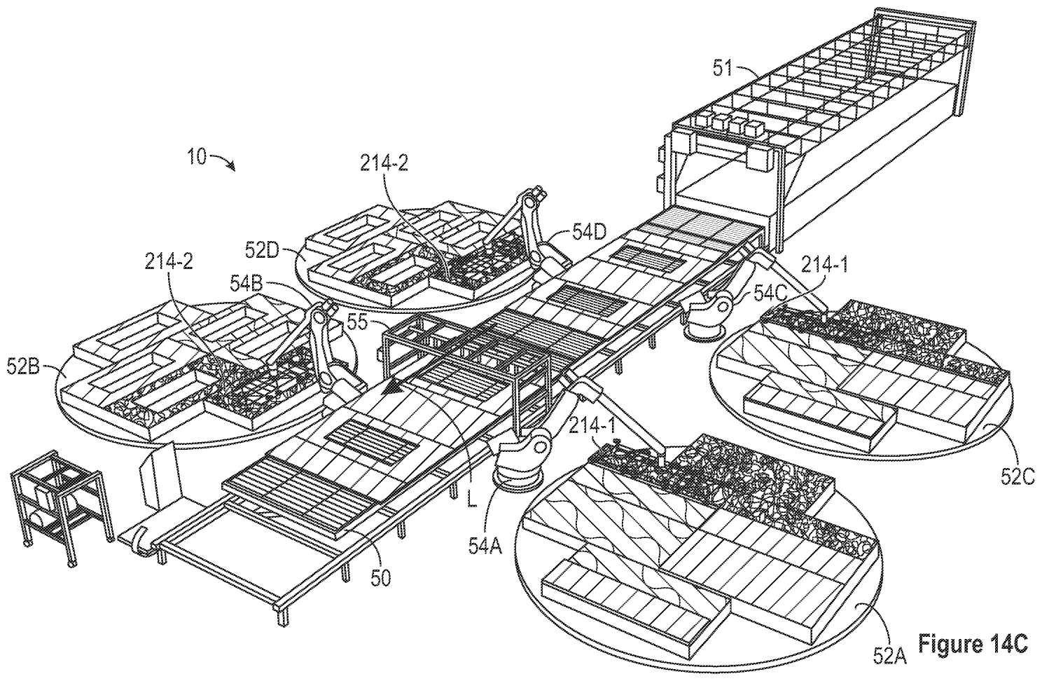

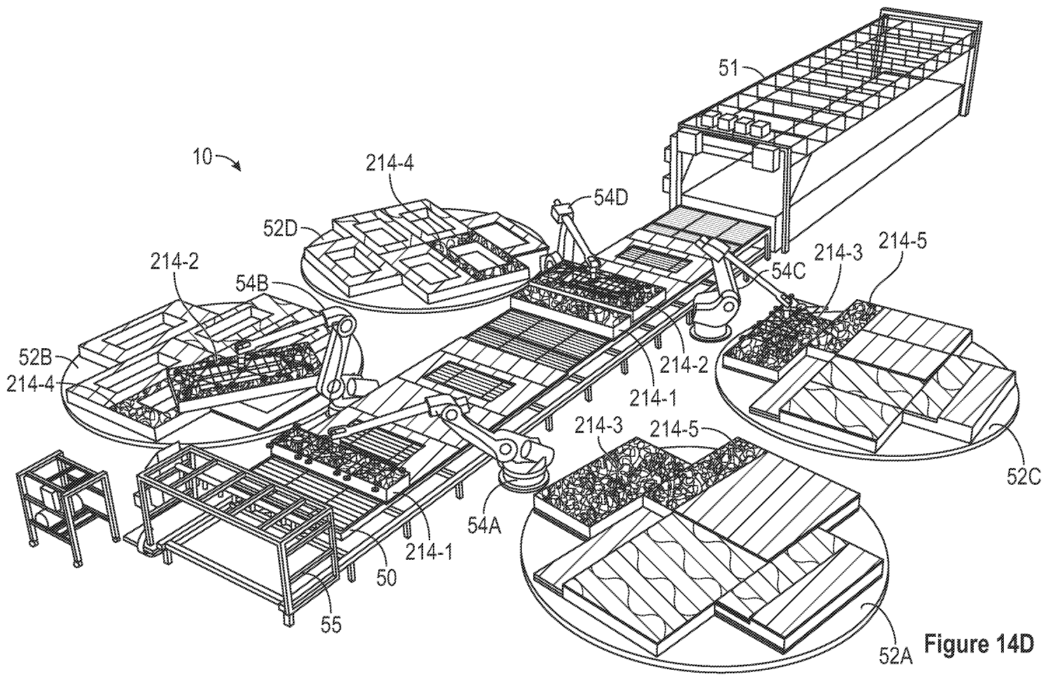

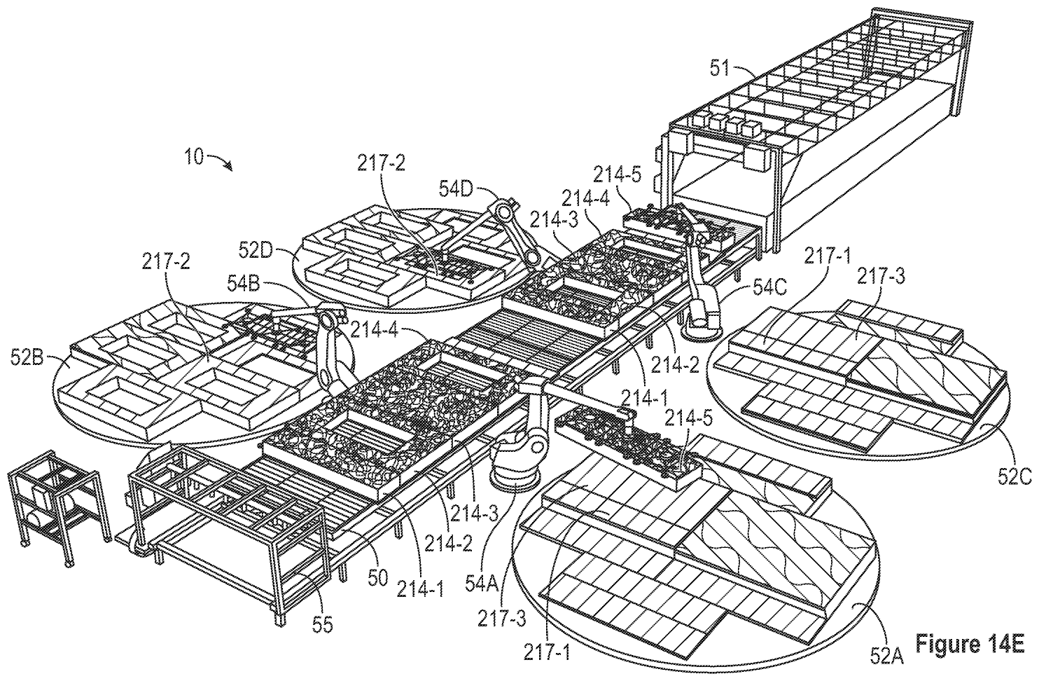

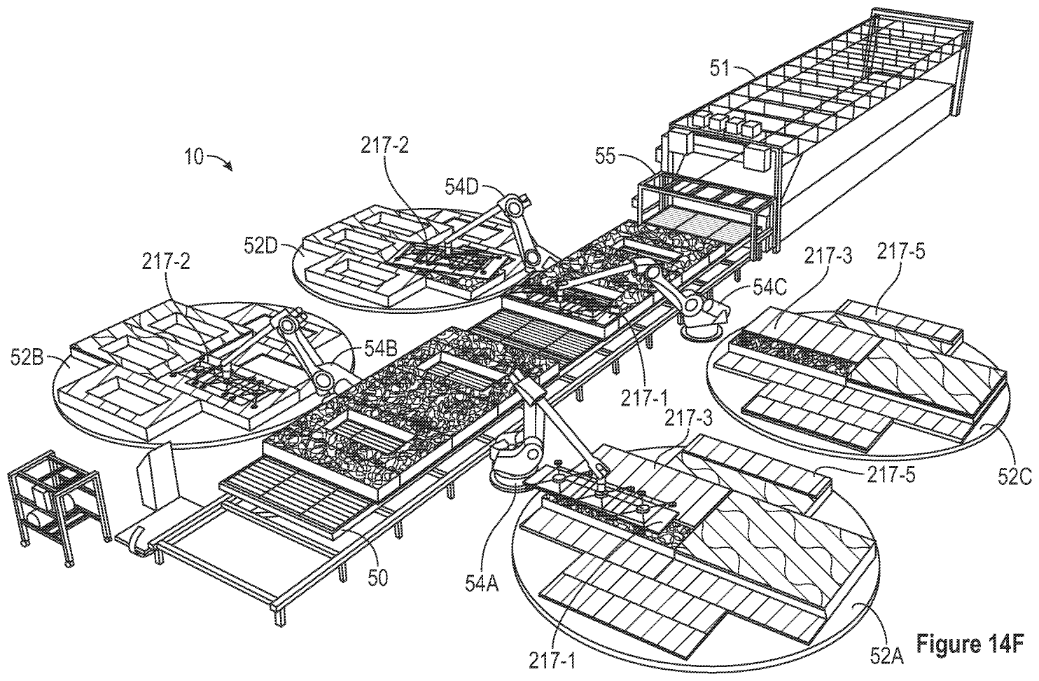

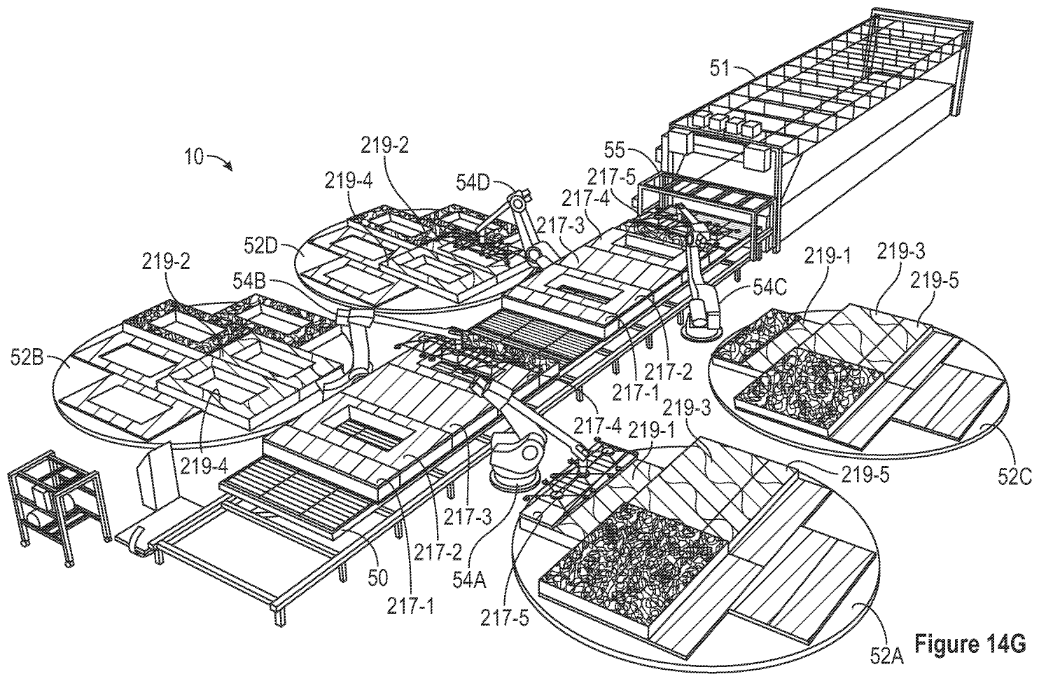

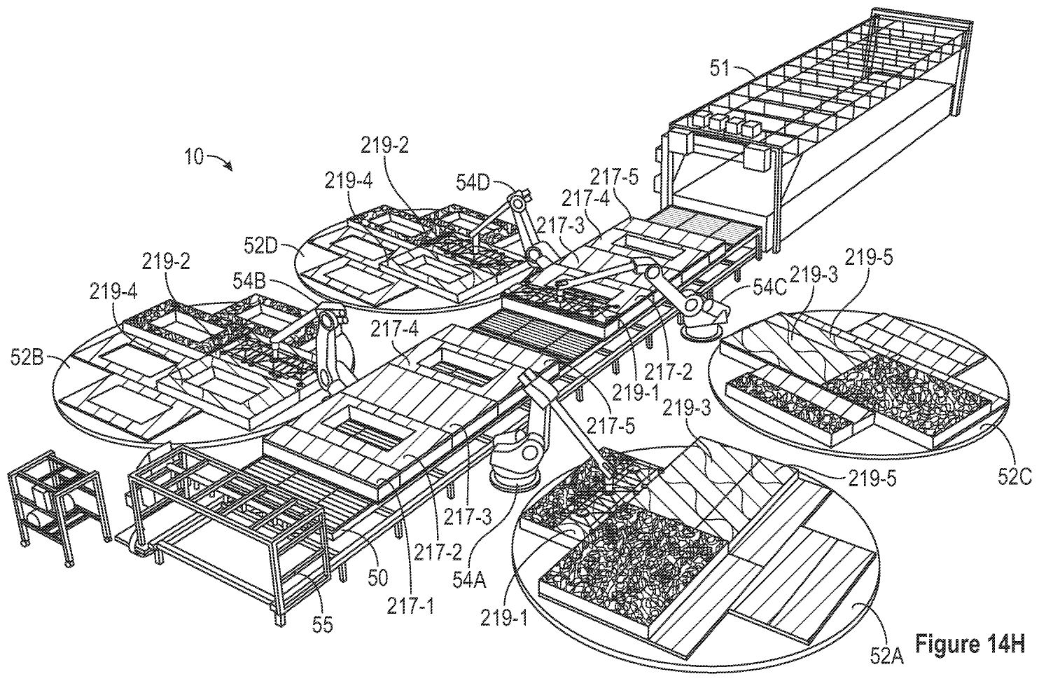

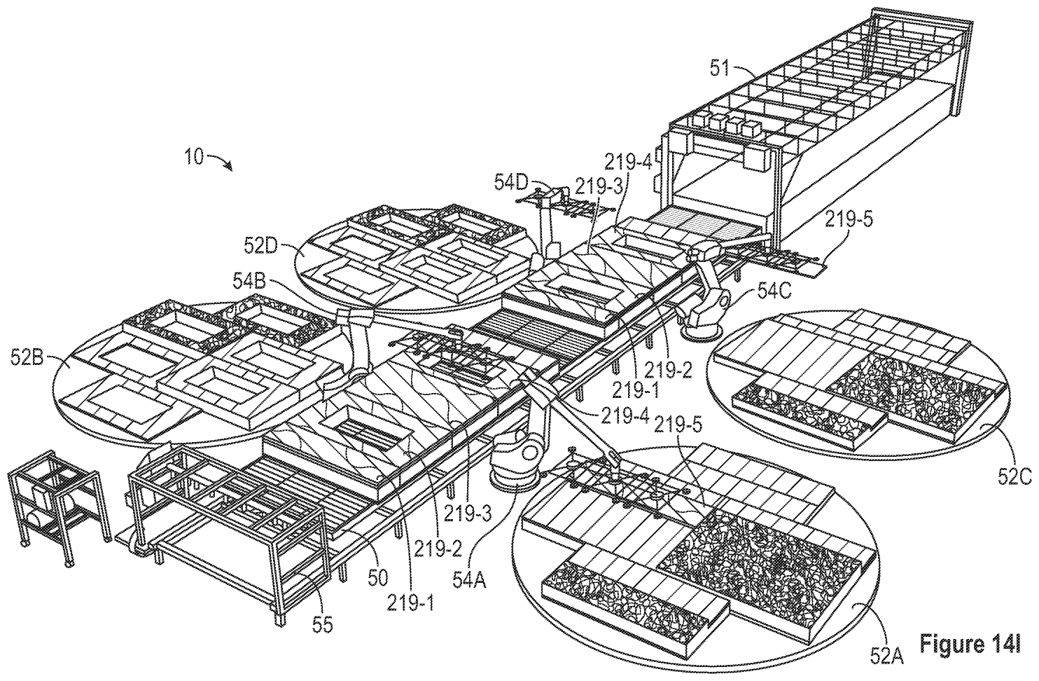

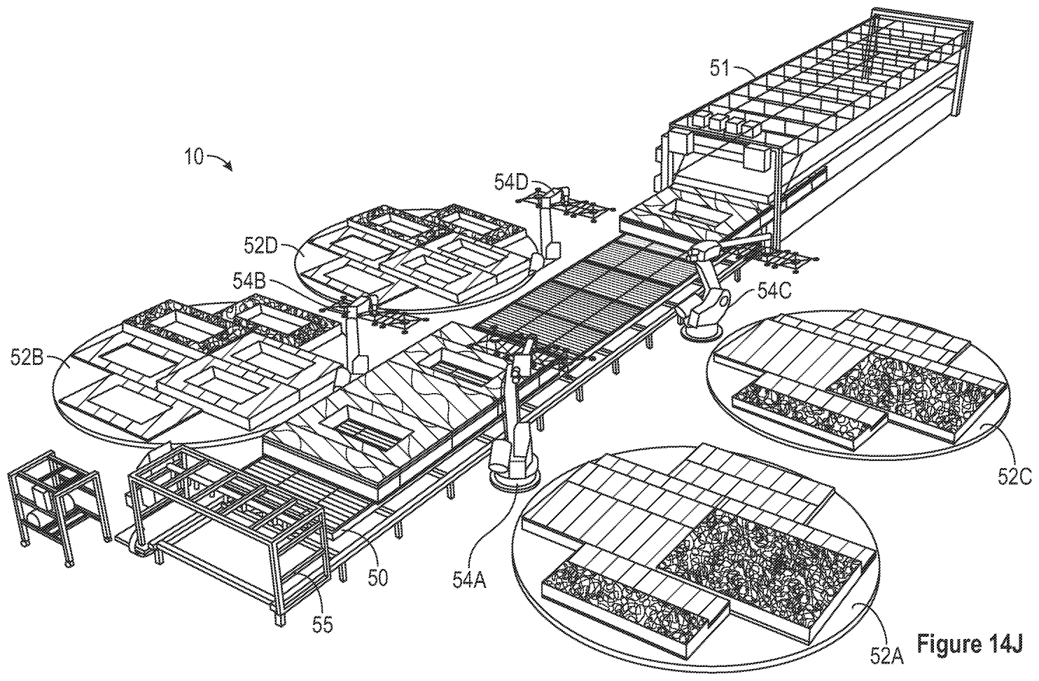

In the embodiment of floor component 300 utilized in the structure 150 of FIGS. 1-5, I-beam assembly 325 is located at the mid-point between first transverse floor edge 120 and second transverse floor edge 118, and no hinge assemblies 329A are utilized elsewhere within floor component 300, such as proximate to first transverse floor edge 120 and second transverse floor edge 118. Therefore, to assist in smoothly rotating floor portion 300b, there is provided adjacent first transverse floor edge 120 a first floor end hinge assembly 345A joining floor portions 300a and 300b, and there is provided adjacent second transverse floor edge 118 a second floor end hinge assembly 345A joining floor portions 300a and 300b. The locations of both first and second floor end hinge assemblies 345A is indicated in FIG. 9. Floor end hinge assembly 345A comprises two identical floor end hinge portions 350A (not specified in the figures). A description of the construction of floor end hinge assembly 345A and its floor end hinge portions 350A is set forth in U.S. Nonprovisional patent application Ser. No. 17/527,520 entitled “Folding Beam Systems”, filed Nov. 16, 2021 and having the same inventors as the subject application. The contents of that U.S. Nonprovisional patent application Ser. No. 17/527,520 entitled “Folding Beam Systems”, filed Nov. 16, 2021 and having the same inventors as the subject application, is incorporated by reference as if fully set forth herein, particularly the description of the construction of floor end hinge assembly 345A and its floor end hinge portions 350A set forth for example in ¶¶ 0090-0093 and in FIGS. 14A-14B thereof.

### Roof Component (400)

Typically, a structure 150 will utilize one roof component 400; thus roof component 400 generally is the full roof of structure 150.

A. General Description

Roof component 400 has a generally rectangular perimeter. FIGS. 1, 4 and 5 depict roof component 400 in accordance with the present inventions. The perimeter of roof component 400 is defined by first longitudinal roof edge 406, first transverse roof edge 408, second longitudinal roof edge 416 and second transverse roof edge 410. In particular, (a) first longitudinal roof edge 406, (b) first transverse roof edge 408, (c) second longitudinal roof edge 416 and (d) second transverse roof edge 410 of roof component 400 generally coincide with (i.e., overlie) (w) first longitudinal edge 106, (x) first transverse edge 108, (y) second longitudinal edge 116 and (z) second transverse edge 110, respectively, of structure 150.

The length and width of roof component 400 can vary in accordance with design preference, subject as desired to the various considerations described in this disclosure. In the particular embodiment of structure 150 depicted in FIGS. 1, 4 and 5, the length and width of roof component 400 approximates the length and width of floor component 300.

Roof component 400 and its constituent elements are generally designed and dimensioned in thickness and in other respects to accommodate the particular loads to which roof component 400 may be subject. It is preferred that roof component 400 utilize a multi-layered, laminate design, such as that described in connection with FIG. 7. In the embodiment shown in FIGS. 4 and 5, the top-most surface of roof component 400 comprises sheet metal layer 205 of first structural layer 210, with sheet metal layer 205 being 24 gauge galvanized steel approximately 0.022-0.028 inch thick. Below sheet metal layer 205 there are provided foam panels 214 of foam panel layer 213, with foam panels 214 in the embodiment shown in FIGS. 4 and 5 being EPS foam for example approximately 7.125 inches thick. Below foam panel layer 213 there is provided sheet metal layer 216 of second structural layer 215, with sheet metal layer 216 being 24 gauge galvanized steel approximately 0.022-0.028 inch thick. Below sheet metal layer 216 of second structural layer 215, there are provided building panels 219 of protective layer 218, with building panels 219 being MgO board approximately 0.25 inch (6 mm) thick.

The perimeter of roof component 400 is generally provided with exterior edge reinforcement. As exterior edge reinforcement for the embodiment of roof component 400 shown in FIGS. 4 and 5, a first shoulder beam 435 (visible edge-on in FIG. 4) is positioned at the first longitudinal roof edge 406 of roof component 400, a second shoulder beam 435 (visible edge-on in FIG. 5) is positioned at the first transverse roof edge 408 of roof component 400, a third shoulder beam 435 (visible edge-on in FIG. 5) is positioned at the second transverse roof edge 410 of roof component 400, and a fourth shoulder beam 435 (visible edge-on in FIG. 4) is positioned at the second longitudinal roof edge 416 of roof component 400. In addition to protecting the exterior edges of foam panel material, the exterior edge reinforcement provided by shoulder beams 435 assists in resisting vertical loads and transferring such loads to lower floors through underlying wall components 200 supporting roof component 400, and then to the foundation of the finished structure 150. Such exterior edge reinforcement can also provide a region for fastening like regions of abutting enclosure components 155 (underlying and any overlying). Shoulder beams 435 of roof component 400 can be fabricated from laminated strand lumber board 7.125″ deep and 1.5″ thick.

B. Roof Partitioning

The roof component 400 of structure 150 is partitioned into roof portions 400a, 400b and 400c. FIG. 1 shows roof portions 400a, 400b and 400c in perspective view, and FIG. 4 shows roof portions 400a, 400b and 400c in section view, edge-on.

Each of the roof portions 400a, 400b and 400c is a planar generally rectangular structure, with roof portion 400a adjoining roof portion 400b, and roof portion 400b adjoining roof portion 400c. Interior edge 412c of roof component 400c abuts a first interior edge 412b of roof component 400b, as shown in FIG. 4. For interior edge reinforcement, a reinforcing board 437 is positioned adjacent interior edge 412c, and a reinforcing board 437 is positioned against first interior edge 412b. Interior edge 412a of roof portion 400a abuts a second interior edge 412b of roof portion 400b, as shown in FIG. 4. For interior edge reinforcement, a reinforcing board 437 is positioned adjacent interior edge 412a, and a reinforcing board 437 is positioned against second interior edge 412b. In the embodiment shown in FIGS. 1 through 6, the interior edge reinforcement provided by reinforcing boards 437 of roof component 400 is laminated strand lumber board 7.125″ deep and 1.5″ thick.

Referring to structure 150 shown in FIG. 4, roof portion 400a is fixed in position relative to first wall portion 200s-1, third wall portion 200s-3 and wall component 200R. Roof portion 400a is joined to roof portion 400b with hinge structures provided between interior edge 412a of roof portion 400a and second interior edge 412b of roof portion 400b. Such hinge structures are adapted to permit roof portion 400b to pivot through up to one hundred and eighty degrees)(180° of arc about a horizontal axis 405a, located proximate the top of roof component 400 and shown in FIG. 4, between the roof fully folded position shown in FIG. 3, where roof portion 400b lies flat against roof portion 400a, and the fully unfolded position shown in FIG. 4.

In turn, roof portion 400b is joined to roof portion 400c with hinge structures provided between first interior edge 412b of roof portion 400b and interior edge 412c of roof portion 400c. Such hinge structures are adapted to permit roof portion 400c to pivot through up to one hundred and eighty degrees)(180° of arc about a horizontal axis 405b, located proximate the bottom of roof component 400 and shown in FIG. 4, between the folded position shown in FIG. 3, where roof portion 400c lies flat against roof portion 400b (when roof portion 400b is positioned to lie flat against roof portion 400a), and the fully unfolded position shown in FIG. 4. Particular embodiments of suitable hinge structures for joining roof portion 400a to roof portion 400b, and for joining roof portion 400b to roof portion 400c, are described below.

C. Hinged Vertical Load Transfer Components

FIGS. 10A and 10B shows a beam assembly 425 that can be placed within roof component 400 to provide reinforcement in the direction along the beam and assist in transferring vertical loads borne by floor component 300 to its edges. Beam assembly 425 includes three I-beams 426a, 426b and 426c . I-beam 426a is positioned approximately in the middle of roof portion 400a, I-beam 426b is positioned approximately in the middle of floor portion 400b, I-beam 426c is positioned approximately in the middle of floor portion 400c, and each of I-beams 426a, 426b and 426c is oriented in the transverse direction. A hinge assembly 429B joins I-beam 426a to I-beam 426b.In addition, a hinge assembly 429C joins I-beam 426b to I-beam 426c . The hinge assemblies 429B and 429C permit beam assembly 425 to be folded to a beam folded position, shown in FIG. 10B, and unfolded to a beam unfolded position, shown in FIG. 10A. Further, the hinge assemblies 429B and 429C can be locked when beam assembly 425 is in the beam unfolded position, which transforms beam assembly 425 into a rigid structure that will reinforce roof component 400 in the direction perpendicular to its axes of folding.

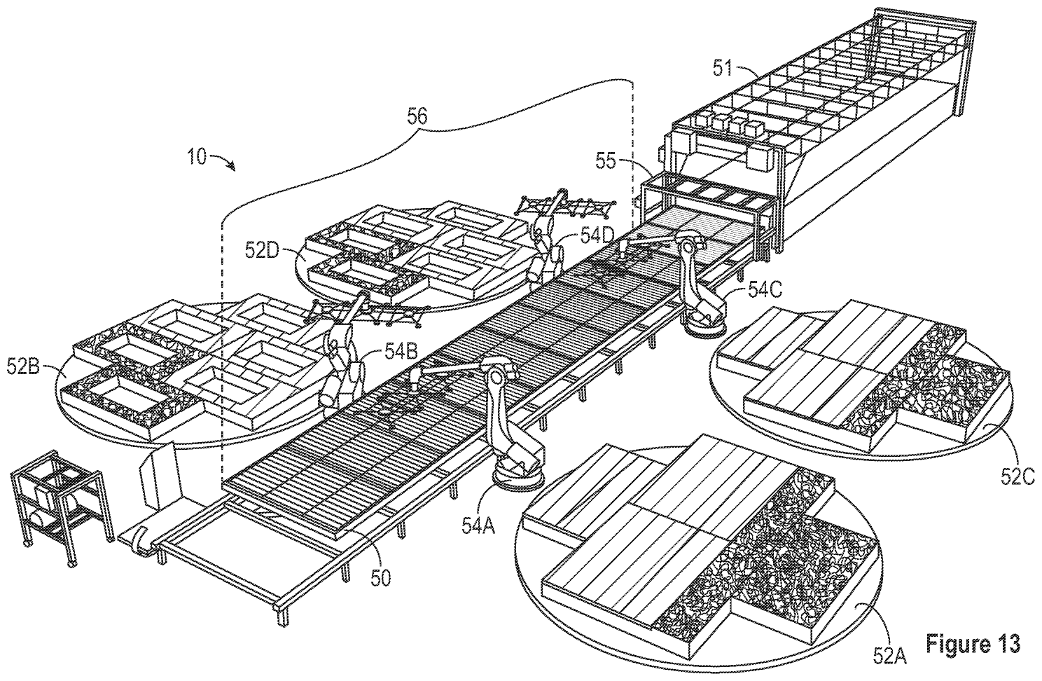

Hinge assembly 429B comprises two identical hinge assembly portions 430B partnered together to form a pivoted junction, as shown in FIGS. 10A and 10B. Likewise, hinge assembly 429C comprises two identical hinge assembly portions 430C partnered together to form a pivoted junction, as shown in FIGS. 10A and 10B. A description of the construction of hinge assembly 429B and its hinge assembly portions 430B, and a description of hinge assembly 429C and its hinge assembly portions 430C, are each set forth in U.S. Nonprovisional patent application Ser. No. 17/527,520 entitled “Folding Beam Systems”, filed Nov. 16, 2021 and having the same inventors as the subject application. The contents of that U.S. Nonprovisional patent application Ser. No. 17/527,520 entitled “Folding Beam Systems”, filed Nov. 16, 2021 and having the same inventors as the subject application, is incorporated by reference as if fully set forth herein, particularly the description of the construction of hinge assembly 429B and its hinge assembly portions 430B set forth for example in ¶¶ 0106-0118 and in FIGS. 16-19 and 13C-13E thereof, and particularly the description of the construction of hinge assembly 429C and its hinge assembly portions 430C set forth for example in ¶¶ 0119-0124 and in FIGS. 20-23 and 13C-13E thereof.

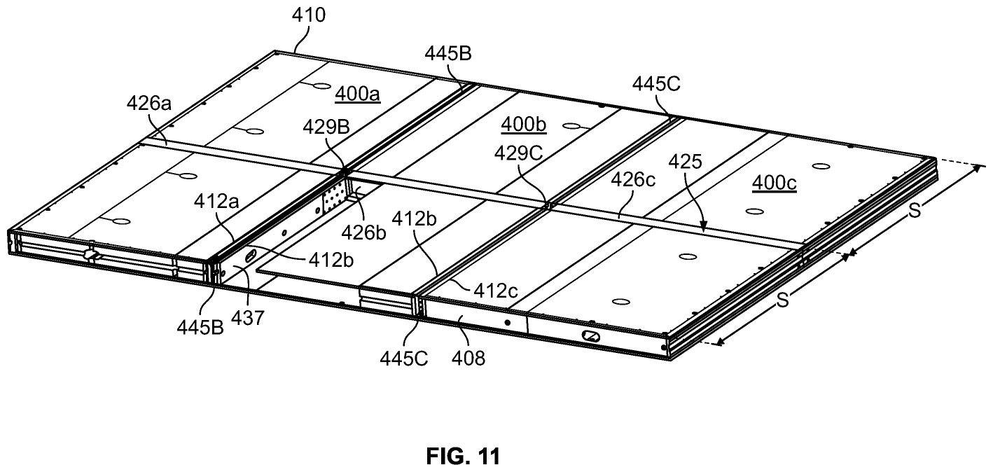

In the embodiment of roof component 400 utilized in the structure 150 of FIGS. 1-5, I-beam assembly 425 is located at the mid-point between first transverse roof edge 408 and second transverse roof edge 410, and no hinge assemblies 429B or 429C are utilized elsewhere within roof component 400, such as proximate to first transverse roof edge 408 or second transverse roof edge 410. Therefore, to assist in smoothly rotating roof portion 400b relative to roof portion 400a, there is provided adjacent first transverse roof edge 408 a first roof end hinge assembly 445B joining roof portions 400a and 400b, and there is provided adjacent second transverse roof edge 410 a second roof end hinge assembly 445B joining roof portions 400a and 400b. Additionally, to assist in smoothly rotating roof portion 400c relative to roof portion 400b, there is provided adjacent first transverse roof edge 408 a first roof end hinge assembly 445C joining roof portions 400b and 400c, and there is provided adjacent second transverse roof edge 410 a second roof end hinge assembly 445C joining roof portions 400b and 400c. The locations of first and second roof end hinge assemblies 445B are indicated in FIG. 11, and the locations of first and second roof end hinge assemblies 445C are indicated in FIG. 11.

Roof end hinge assembly 445B comprises two identical roof end hinge portions 450B (not specified in the figures), and roof end hinge assembly 445C comprises two identical roof end hinge portions 450C (not specified in the figures). A description of the construction of roof end hinge assembly 445B and its roof end hinge portions 450B, and a description of roof end hinge assembly 445C and its roof end hinge portions 450C, are each set forth in U.S. Nonprovisional Patent Application No. 17/527,520 entitled “Folding Beam Systems”, filed Nov. 16, 2021 and having the same inventors as the subject application. The contents of that U.S. Nonprovisional patent application Ser. No. 17/527,520 entitled “Folding Beam Systems”, filed Nov. 16, 2021 and having the same inventors as the subject application, is incorporated by reference as if fully set forth herein, particularly the description of the construction of roof end hinge assembly 445B and its roof end hinge portions 450B, and their positioning, set forth for example in ¶¶ 0127-0130 and in FIGS. 25A-25C thereof, and particularly the description of the construction of roof end hinge assembly 445C and its roof end hinge portions 450C, and their positioning, set forth for example in ¶¶ 0131-0132 and in FIGS. 25D thereof.

### Enclosure Component Manufacture

A. General Description

FIG. 13 depicts a facility 10 for fabricating the enclosure components 155. The facility comprises a conveyor table 50, a press table 51, and in the embodiment shown in FIG. 13, four material turntables 52A, 52B, 52C and 52D and four robotic assemblers MA, MB, MC and MD. There is also an adhesive spray gantry 55 straddling the conveyor table 50. Whether partitioned or not, all of the enclosure components 155—wall components 200, floor components 300 and roof components 400—can be formed on the same facility 10.

Conveyor table 50 is provided with a plurality of cylindrical rollers to facilitate movement of pieces from the assembly area 56 onto the press table 51. The work pieces are built up, layer upon layer, in the assembly area 56, and then moved into the press table 51. The work pieces can be enclosure components 155, partitioned portions thereof, or sub-assemblies thereof, such as laminate panel sections 250, described below. The movement of materials from turntables 52A, 52B, 52C and 52D onto conveyor table 50 can be done manually, by manufacturing personnel. Alternatively, robotic assemblers, such as robotic assemblers 54A, 54B, 54C and 54D depicted in FIGS. 13 and 14, can be employed to carry out some or all of such movement, either under the control of manufacturing personnel, or under the control of an appropriately-programmed computer controller.

Press table 51 preferably employs a vacuum bag system to press together the layers of the work pieces. Spray gantry 55 is movable over conveyor table 50 between a first position proximate to press table 51 and a second position distal from press table 51. Spray gantry 55 is provided with a number of downward-directed spray heads for spraying adhesive, such as polyurethane based construction adhesive, onto the work pieces, as directed.

The facility 10 shown in FIG. 13 is designed to fabricate up to two enclosure components 155 simultaneously. Thus robotic assemblers 54A and 54B are positioned as opposed pairs with conveyor table 50 between them, as shown in FIG. 13, and are used to move sheets and panels from turntables 52A and 52B, respectively, to appropriate locations on conveyor table 50 to form a first enclosure component 155. Likewise, robotic assemblers 54C and 54D are positioned as opposed pairs with conveyor table 50 between them, as shown in FIG. 13, and are used to move sheets and panels from turntables 52C and 52D, respectively, to appropriate locations on conveyor table 50 to form a second enclosure component 155. Looking down at turntables 52A-52D in FIG. 13 and assuming them to have the face of a clock (with the twelve o'clock position being closest to press table 51), robotic assemblers 54A and 54C are adapted to move sheets and panels from the access positions of turntables 52A and 52C respectively (proximate the nine o'clock position on turntables 52A and 52C), to conveyor table 50. Correspondingly, robotic assemblers 54B and 54D are adapted to move sheets and panels from the access positions of turntables 52B and 52D respectively (proximate the three o'clock position on each of turntables 52B and 52D), to conveyor table 50.

In the facility 10 shown in FIG. 13, the access positions on turntables 52A-52D are made sufficiently large so as to be able to position two or more sheets and/or panels adjacent to each other at those access positions (i.e., an access position can accommodate two or more adjacent stacks of planar fabrication elements). This permits robotic assemblers 54A-54D to have access to two or more sheets and/or panels that are not stacked, one or top of another, without the need to rotate further the turntables 52A-52D. Further, the stacks need not be homogenous, but can be mixed stacks comprising sheets and panels appropriately interspersed for more efficient assembly; i.e., a stack may include both foam panels and metal sheets. In addition, the sheets and/or panels in a stack may have different sizes, and a stack may contain two or more adjacent sheets and/or stacks overlying or underlying a single sheet and/or panel, depending upon the dimensions of the sheets and/or panels and the sequence of fabrication.

As directed, turntables 52A-52D are rotated to bring sheets and panels to their respective access positions. In the manufacturing sequence described below, each turntable is rotated counterclockwise in ninety)(90° degree steps, as sheets and/or panels are removed from it, to bring into the access position the next appropriate sheets and/or panels. The rotation of the turntables 52A-52D can be manual, or power-driven, and in the latter case can be conducted using an appropriately-programmed computer controller, which can also control the operation of robotic assemblers 54A-54D and spray gantry 55.

For exemplary purposes, the sequence for fabricating two wall components 200, specifically wall component 200P, is described in connection with FIGS. 14A-14J. However, it should be understood that the fabrication sequence described below applies equally to the fabrication of floor components 300 and roof components 400, and to the fabrication of partitioned portions thereof, and to sub-assemblies thereof, particularly laminate panel sections 250 (described below). For the illustrated wall components 200, those sheets 206, 217 and panels 214, 219 in which there will be desired apertures, such as door apertures 202 and window apertures 204, are pre-cut, where appropriate, with the desired apertures, and then placed on the turntables 52B and 52D, which are located on a first side of conveyor table 50, as indicated in FIGS. 14A-14J. The sheets and panels of this wall component 200 in which there will not be formed any such desired apertures are correspondingly placed on the turntables 52A and 52C, which are located on the second side of conveyor table 50, again, as indicated in FIGS. 14A-14J. As an alternative, the formation of any door and window apertures 202, 204 can be deferred until after the fabrication steps described herein.

In general, the manufacturing sequence comprises placing on conveyor table 50 the metal sheets 206 forming the sheet metal layer 205 of the first structural layer 210, followed by the foam panels 214 of foam panel layer 213, the metal sheets 217 forming the sheet metal layer 216 of second structural layer 215, and lastly the building panels 219 of protective layer 218, in that order. In the two exemplary wall components 200 shown being fabricated in FIGS. 14A-14J, each of the layers of the wall component 200 (first structural layer 210, foam panel layer 213, second structural layer 215 and protective layer 218) is made from five sheets or panels. Accordingly, first structural layer 210 is made from five metal sheets 206 (consecutively denominated 206-1 to 206-5) that are positioned on conveyor table 50 adjacent each other; foam panel layer 213 is made from five foam panels 214 (consecutively denominated 214-1 to 214-5) that are positioned on conveyor table 50 adjacent each other; second structural layer 215 is made from five metal sheets 217 (consecutively denominated 217-1 to 217-5) that are positioned on conveyor table 50 adjacent each other; and protective layer 218 is made from five building panels 219 (consecutively denominated 219-1 to 219-5) that are positioned on conveyor table 50 adjacent each other.

For the exemplary wall components 200 fabricated in the manner shown in FIGS. 14A-14J, even-numbered sheets and panels (e.g., 206-2, 206-4, 214-2, 214-4, etc.) have apertures, specifically window apertures 204, and odd-numbered sheets and panels (e.g., 206-1, 206-3, 214-1, 214-3, etc.) do not have any such apertures. Although for ease of understanding the assembly sequence, the sheets and panels in FIGS. 13 and 14A-14J are depicted as the same size, with one placed directly upon the other on conveyor table 50, the sheets and panels can be sized and/or placed so that the seams between adjacent sheets or panels are offset from the seams of overlying or underlying sheets or panels, so as to yield an overlapping relationship between the sheets and panels of different layers, with the goal of increasing the strength of the enclosure components 155 being fabricated, in this case wall components 200.

B. Height/Span Relationships for Manufacturing

It is preferred that there be a specific dimensional relationship among enclosure components 155. In reference to the structure 150 shown in FIGS. 1-5, it is preferred that the height “H” of wall components 200 be the same as the span “Sf” between the I-beam assembly 325 of floor component 300 and either its first transverse floor edge 120 or its second transverse floor edge 118, with I-beam assembly 325 being located at the middle of floor component 300. Correspondingly, it is preferred that the height of wall components 200 be the same as the span “Sr” between the I-beam assembly 425 of roof component 400 and either its first transverse roof edge 408 or its second transverse roof edge 410, with I-beam assembly 425 being located at the middle of roof component 400. Thus, it is preferred that H=Sf=Sr. Accordingly, Sf and Sr are referred to herein simply as “S”, the panel span.

Making H=S improves the production throughput of manufacturing facility 10. Specifically, manufacturing facility 10 can be tasked with making multiple laminate panel sections 250 sharing a common dimension based upon the bed width 49 of conveyor table 50 shown in FIG. 13, which can then be used to assemble either floor components 300 or roof components 400. Each laminate panel section 250 has a rectangular shape and a panel span of length “S”. In an embodiment of manufacturing facility 10 shown in FIG. 13, the bed width 49 can accommodate work pieces having a dimension up to approximately 9.5 feet. Correspondingly, the panel span S between I-beam assembly 325 and either of the first and second transverse floor edges 120, 118 can be 9.5 feet (see FIG. 9, in which span S can be seen between I-beam assembly 325 and first transverse floor edge 120; see also FIG. 2). Likewise, the panel span S between I-beam assembly 425 either of the first and second transverse roof edges 408, 410 can be 9.5 feet (see FIG. 11; see also FIG. 1). Wall components 200 can also be manufactured utilizing laminate panel sections 250 of span S. Accordingly, each wall component 200 in the embodiment of structure 150 shown in FIG. 1 has a height H of 9.5 feet; either with the same thickness as floor components 300 and/or roof components 400, or with a different thickness, as follows from utilizing foam panels 214 having a different thickness from the thickness of the foam panels 214 used to fabricate floor components 300 and/or roof components 400.

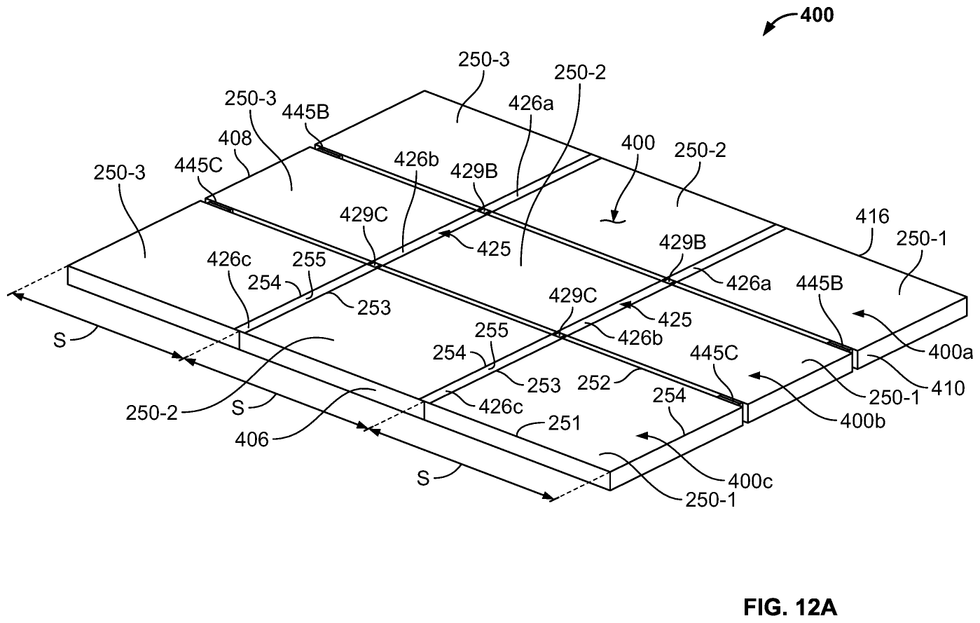

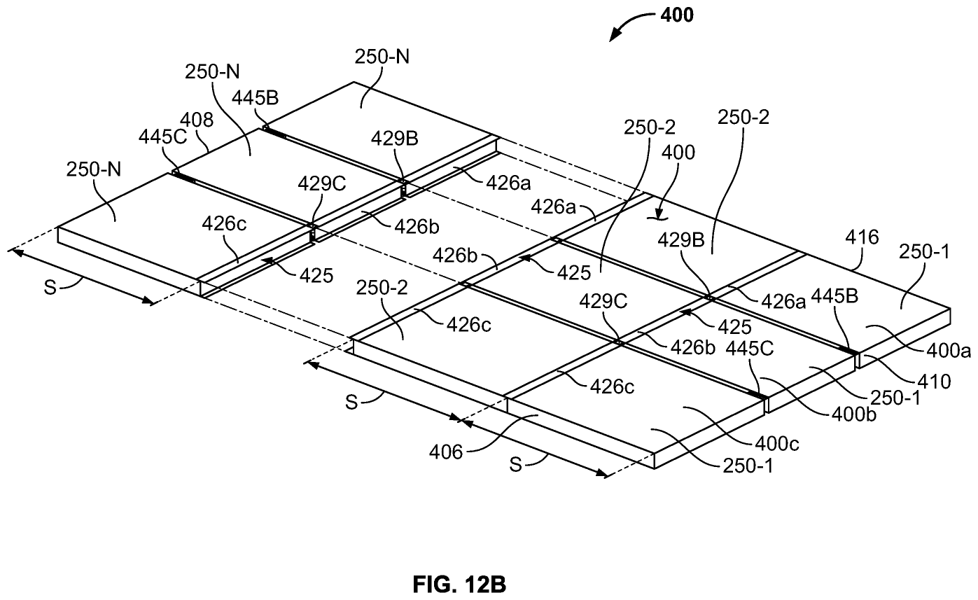

These same height/span relationships can also be utilized to make structures 150 with different footprints (i.e., longer in the longitudinal direction than depicted in FIG. 1), as where two of its opposing wall components 200 are longer than the other two opposing wall components 200. For example, FIG. 12A depicts a roof component 400 approximately 1.5 times longer in the longitudinal direction than in the transverse direction. In this example, roof portions 400a, 400b and 400c are each assembled from a series of three laminate panel sections 250 having the same geometry and dimensions, denominated laminate panel sections 250-1, 250-2 and 250-3 respectively in FIG. 12A. As indicated above, each laminate panel section 250 has a rectangular shape and is defined by a panel edge 251, an opposed panel edge 252, an orthogonal edge 253 and an opposed orthogonal edge 254, as shown for an exemplary laminate panel section 250-1 in FIG. 12A, with orthogonal edges 253, 254 adjacent panel edges 251, 252 to form the rectangular shape. Panel edges 251 and 252 each has a panel span of length “S”.

For each roof portion 400a, 400b and 400c shown in FIG. 12A, the three laminate panel sections 250-1, 250-2 and 250-3 are positioned adjacent each other with their orthogonal edges side-by-side, to provide a pair 255 of adjacent orthogonal edges 253, 254 between laminate panel section 250-1 and 250-2, and a pair 255 of adjacent orthogonal edges 253, 254 between laminate panel sections 250-2 and 250-3; thus there are two pairs of adjacent orthogonal edges for the three laminate panel sections 250-1, 250-2 and 250-3 of roof portion 400c. Likewise, there are two pairs of adjacent orthogonal edges 253, 254 for the three laminate panel sections 250-1, 250-2 and 250-3 of roof portion 400b, and there are two pairs of adjacent orthogonal edges 253, 254 for the three laminate panel sections 250-1, 250-2 and 250-3 of roof portion 400a (the latter two pairs being omitted from FIG. 12A for simplicity). A first beam assembly 425 is positioned between the pair 255 of orthogonal edges 253, 254 of the laminate panel sections 250-1 and 250-2 forming each of roof portions 400a, 400b and 400c, and a second beam assembly 425 is positioned between the pair 255 of orthogonal edges 253, 254 of the laminate panel sections 250-2 and 250-3 forming each of roof portions 400a, 400b and 400c. As made evident by the disclosure above, the proximate ends of the corresponding beams 426a and 426b of each of the first and second beam assemblies 425 are joined by a hinge assembly 429B, and the proximate ends of the corresponding beams 426b and 426c of each of the first and second beam assemblies 425 are joined by a hinge assembly 429C.

Each laminate panel section 250 in FIG. 12A can have a panel span S of 9.5 feet in the longitudinal direction, consistent with bed width 49 shown in FIG. 13. Accordingly, each of the three roof portions 400a, 400b and 400c are approximately 3 S long, or approximately 29 feet, in the longitudinal direction, and correspondingly the first longitudinal roof edge 406 and second longitudinal roof edge 416 of roof component 400 each has a length of approximately 29 feet. In comparison, the corresponding dimensions of roof portions 400a, 400b and 400c in the transverse direction are not limited by bed width 49, and can be varied as desired.

The foregoing design relationship can be extended to a structure 150 of any length in the longitudinal direction simply by adding, in the case of roof component 400 as an example, one or more additional beam assemblies 425 and further laminate panel sections. Thus as shown in FIG. 12B, there is provided a roof component 400 with roof portions 400a, 400b and 400c, in which each roof portion contains N laminate panel sections 250, denominated 250-1, 250-2, . . . , 250-N. Each of the N laminate panel sections 250 has a panel span of length S. As a result, the longitudinal edges of each roof portion 400a, 400b and 400c have a length equal to N×S, and correspondingly the first longitudinal roof edge 406 and second longitudinal roof edge 416 of roof component 400 each has a length of N×S. As is evident, there also will be N−1 pairs 255 of adjacent orthogonal edges in each of roof portions 400a, 400b and 400c, with a transversely oriented beam 425 positioned between each of the N−1 pairs 255.

The floor component 300 for the structure 150 utilizing the roof component 400 shown in FIG. 12B can also be fabricated from laminate panel sections 250 having a panel span of length S, and thus, in the case of a structure 150 having a cuboid shape, the longitudinal edges of each floor portion 300a and 300b have a length equal to N×S, and correspondingly the first longitudinal floor edge 117 and the second longitudinal floor edge 119 of floor component 300 each has a length of N×S. Likewise, each wall structure (in this disclosure, a “wall structure” includes any wall component 200 and any wall portion of a wall component 200) is fabricated from laminate panel sections 250 having a panel span of length S, with each panel edge of span S vertically oriented so that each wall structure has a height equal to S.

C. Sheet/Panel Design for Manufacturing

For enclosure components 155 having the construction disclosed herein in reference to FIG. 7, the metal sheets 206 and 217 that can be used to form first structural layer 210 and second structural layer 215 respectively can be entirely flat and juxtaposed in a simple abutting relationship. Optionally, metal sheets 206 and 217 can be provided with edge structures that facilitate placement of sheets and panels during manufacture.

Particular interior and exterior edge structure designs for metal sheets 206 and 217 are described in U.S. Nonprovisional Patent Application No. 17/504,883 entitled “Sheet/Panel Design for Enclosure Component Manufacture,” having the same inventors as the inventions described herein and filed on Oct. 19, 2021. The contents of U.S. Nonprovisional patent application Ser. No. 17/504,883 entitled “Sheet/Panel Design for Enclosure Component Manufacture,” having the same inventors as the inventions described herein and filed on Oct. 19, 2021, are incorporated by reference as if fully set forth herein, particularly including the exterior and interior edge structure designs described for example at ¶¶ 00187-00205 and 00212 and in FIGS. 8, 9A-9C, 23A-23J and 24A-24B thereof.

D. Sheet/Panel Manufacturing Sequence

To fabricate an enclosure component 155 of laminate design in accordance with FIG. 7 (as exemplified by the wall components 200, specifically wall components 200P, prepared in FIGS. 14A-14J), Table 1 identifies the turntable on which is located each of the required sheets 206, 217 and panels 214, 219, as well as the sequence in which they are moved, either by manufacturing personnel or by robotic assemblers MA and MB, from the turntables 52A and 52B to conveyor table 50. A like sequence can be followed for all enclosure components 155—wall components 200, floor components 300 and roof components 400—used in structure 150 depicted in FIG. 1.

TABLE 1
Sheet/Panel Source and Movement Sequence

| Turntable 52A | Turntable 52B |
|---|---|
| metal sheet 206-1 (1^{st} structural layer 210) | metal sheet 206-2 (1^{st} structural layer 210) |
| Rotate turntable ninety degrees (90°) | |
| metal sheet 206-3 (1^{st} structural layer 210) | metal sheet 206-4 (1^{st} structural layer 210) |
| metal sheet 206-5 (1^{st} structural layer 210) | Rotate turntable ninety degrees (90°) |
| foam panel 214-1 (foam panel layer 213) | foam panel 214-2 (foam panel layer 213) |
| Rotate turntable ninety degrees (90°) | Rotate turntable ninety degrees (90°) |
| foam panel 214-3 (foam panel layer 213) | foam panel 214-4 (foam panel layer 213) |
| Rotate turntable ninety degrees (90°) | |
| foam panel 214-5 (foam panel layer 213) | |
| metal sheet 217-1 (2^{nd} structural layer 215) | metal sheet 217-2 (2^{nd} structural layer 215) |
| metal sheet 217-3 (2^{nd} structural layer 215) | Rotate turntable ninety degrees (90°) |
| Rotate turntable ninety degrees (90°) | metal sheet 217-4 (2^{nd} structural layer 215) |
| metal sheet 217-5 (2^{nd} structural layer 215) | Rotate turntable ninety degrees (90°) |
| building panel 219-1 (protective layer 218) | building panel 219-2 (protective layer 218) |
| Rotate turntable ninety degrees (90°) | |
| building panel 219-3 (protective layer 218) | building panel 219-4 (protective layer 218) |
| building panel 219-5 (protective layer 218) | |

Table 1 also applies to the wall assembly 200 fabricated from the sheets 206, 217 and panels 214, 219 positioned on turntables 52C and 52D; i.e., the column in Table 1 for turntable 52A also applies to turntable 52C, and the column in Table 1 for turntable 52B also applies to turntable 52D.

Step 1: First Structural Layer Formation. FIG. 14A depicts robotic assemblers 54A-54D moving metal sheets 206 from their access positions on turntables 52A-52D to pre-selected locations in assembly area 56 (shown in FIG. 13) on conveyor table 50. In accordance with the movement sequence described in Table 1, robotic assemblers 54A-54D move metal sheets 206-1 through 206-5 in sequence to conveyor table 50 until all sheets forming first structural layer 210 of the two exemplary wall components 200 have been appropriately placed in assembly area 56 on conveyor table 50.

If exterior or interior edge structures are provided on metal sheets 206-1 to 206-5, then those structures should be oriented as set forth in U.S. Nonprovisional patent application Ser. No. 17/504,883 entitled “Sheet/Panel Design for Enclosure Component Manufacture,” having the same inventors as the inventions described herein and filed on Oct. 19, 2021, particularly as described at ¶0209 and in FIG. 8 thereof; these portions of application Ser. No. 17/504,883 are hereby incorporated by reference as if fully set forth herein. At the particular point in manufacturing shown in FIG. 14A, robotic assembler 54A has already removed metal sheet 206-1 from its access position on turntable 52A and placed it at a preselected location in assembly area 56 on conveyor table 50, and turntable 52A has been rotated counterclockwise ninety degrees)(90° to bring into the access position the next sheet or panel for placement onto conveyor table 50, in this case metal sheet 206-3. Likewise at the particular point in manufacturing shown in FIG. 14A, robotic assembler 54B has already removed a metal sheet 206-2 from its access position on turntable 52B and placed it at a preselected location in assembly area 56 on conveyor table 50, adjacent metal sheet 206-1.

Step 2: First Adhesive Application. FIG. 14B depicts all metal sheets 206-1 to 206-5 forming first structural layer 210 of the exemplary two wall components 200 properly placed in assembly area 56 on conveyor table 50, after having been moved there by robotic assemblers 54A-54D. The exposed faces of sheets 206 are then coated with adhesive. This step is performed by spray gantry 55, which moves over the exposed faces of sheets 206, in the direction “L”, as indicated by the arrow in FIG. 14C, from a position proximate press table 51 to a position distal from press table 51, while spraying adhesive on the exposed faces of sheets 206, so as to coat substantially the entirety of the exposed faces. Optionally, gantry 55 can remain distal from press table 51 after completing the adhesive spray, as shown in FIG. 14D, until utilized in a subsequent manufacturing step.

Step 3: Foam Panel Layer Formation. FIG. 14D depicts robotic assemblers 54A-54D moving foam panels 214-1 and 214-2 from their access positions on turntables 52A-52D to preselected locations in assembly area 56 (shown in FIG. 13), overlying the adhesive-coated sheets 206 positioned on conveyor table 50. In like manner, and in accordance with the movement sequence described in Table 1, further foam panels 214 are moved in a preselected sequence to conveyor table 50 until all panels forming foam panel layer 213 of the two exemplary wall components 200 are in their appropriate position on conveyor table 50; thus FIG. 14E depicts the final foam panel 214-5 forming foam panel layers 210 of the exemplary two wall components 200 being placed in assembly area 56 on conveyor table 50 by robotic assemblers 54A and 54C. Foam panels 214-1 through 214-5 preferably are pre-cut with channels at appropriate locations to accommodate any interior edge structures on the metal sheets 206-1 to 206-5, and on metal sheets 217-1 to 217-5 (which are to be positioned above the foam panels in Step 5 below), as described in U.S. Nonprovisional patent application Ser. No. 17/504,883 entitled “Sheet/Panel Design for Enclosure Component Manufacture,” having the same inventors as the inventions described herein and filed on Oct. 19, 2021, particularly at ¶0212 and in FIG. 24B thereof; these portions of application Ser. No. 17/504,883 are hereby incorporated by reference as if fully set forth herein.

Following placement of foam panels 214-1 through 214-5 on conveyor table 50 to form foam panel layer 213, any exterior edge reinforcement and sealing structures to be utilized can be positioned in place, as set forth in U.S. Nonprovisional patent application Ser. No. 17/504,883 entitled “Sheet/Panel Design for Enclosure Component Manufacture,” having the same inventors as the inventions described herein and filed on Oct. 19, 2021, particularly at ¶0213, which is hereby incorporated by reference as if fully set forth herein.

Step 4: Second Adhesive Application. Following Step 3, the exposed faces of foam panels 214 are coated with adhesive. This step is performed by spray gantry 55, in a manner similar to the depiction in FIG. 14C. In particular, spray gantry 55 moves over the exposed faces of foam panels 214, while spraying adhesive on the exposed faces so as to coat substantially the entirety of the exposed faces. In the embodiment depicted in FIGS. 14A-14J, spray gantry 55 applies adhesive to foam panels 214 by moving from a position distal from press table 51 to a position proximate press table 51.

Step 5: Second Structural Layer Formation. FIG. 14F depicts robotic assemblers 54A-54D moving metal sheets 217-1 and 217-2 from their access positions on turntables 52A-52D to preselected locations in assembly area 56 (shown in FIG. 13), overlying the adhesive-coated foam panels 24 previously formed on conveyor table 50. In like manner, and in accordance with the movement sequence described in Table 1, further sheets 217 are moved in a preselected sequence to conveyor table 50 until all sheets forming second structural layer 215 of the two exemplary wall components 200 are in their appropriate positions on conveyor table 50. If any exterior or interior edge structures are provided on metal sheets 217-1 to 217-5, then those structures should be oriented as set forth in U.S. Nonprovisional patent application Ser. No. 17/504,883 entitled “Sheet/Panel Design for Enclosure Component Manufacture,” having the same inventors as the inventions described herein and filed on Oct. 19, 2021, particularly as described at ¶ 0216 and in FIG. 8 thereof; these portions of application Ser. No. 17/504,883 are hereby incorporated by reference as if fully set forth herein.

Step 6: Third Adhesive Application. FIG. 14G depicts the final metal sheet 217-5 forming second structural layer 215 of the exemplary two wall components 200 being placed in assembly area 56 on conveyor table 50 by robotic assemblers 54A and 54C. After that placement, the exposed faces of metal sheets 217 are coated with adhesive. This step is performed by spray gantry 55, in a manner similar to the depiction in FIG. 14C. In particular, spray gantry 55 moves over the exposed faces of metal panels 217, while spraying adhesive on the exposed faces so as to coat substantially the entirety of the exposed faces. In the embodiment depicted in FIGS. 14A-14J, spray gantry 55 applies adhesive to metal sheets 217 by moving from a position proximate press table 51 to a position distal from press table 51. Optionally, gantry 55 can remain distal to press table 51 after completing the adhesive spray, as shown in FIG. 14D and 14H, until utilized in a subsequent manufacturing step, or can be returned to a position proximate press table 51.

Step 7: Protective Layer Formation. FIG. 14H depicts robotic assemblers 54A-54D moving building panels 219-1 and 219-2 from their access positions on turntables 52A-52D to preselected locations in assembly area 56 (shown in FIG. 13), overlying the adhesive-coated metal sheets 217 previously formed on conveyor table 50. In like manner, and in accordance with the movement sequence described in Table 1, further building panels 219 are moved in a preselected sequence to conveyor table 50 (FIG. 141) until all sheets forming protective layer 218 of the two exemplary wall components 200 are in their appropriate positions on conveyor table 50. If any seal structures are to be fastened to the interior edges of the wall component 200 (specifically wall component 200P), they can be added during this step 7, as set forth in U.S. Nonprovisional patent application Ser. No. 17/504,883 entitled “Sheet/Panel Design for Enclosure Component Manufacture,” having the same inventors as the inventions described herein and filed on Oct. 19, 2021, particularly as described at ¶ 0219, which is hereby incorporated by reference as if fully set forth herein

Step 8: Laminate Press. After all building panels 219 forming protective layer 218 of the two exemplary wall components 200 are in their assembly position on conveyor table 50, each work piece is moved from conveyor table 50 into press table 51, as exemplified by FIG. 14J. Within press table 51, the work pieces are sandwiched between flexible sheets and a vacuum is applied between the sheets, which causes the panels and sheets of the work piece to be pressed together under atmospheric pressure to finish the laminate structure. In the embodiment shown, the press table is sized to accommodate both work pieces at the same time.

After the laminate press step (Step 8), the wall components 200 are removed from press table 51 and then subject to any desired finishing steps to complete the wall components 200.

Optionally, in appropriate situations certain of the foregoing manufacturing sequence steps can be initiated prior to completion of the previous manufacturing sequence step, such that the manufacturing steps are conducted at least in part in an overlapping manner For example, the foam panel layer formation performed in step 3 can be initiated prior to completion of the adhesive application performed in step 2. Thus as can be seen in FIG. 14C, robotic assemblers 54A-54D are depicted as already starting to engage the foam panels 214 needed for foam panel layer formation, while spray gantry 55 is still spraying adhesive on the exposed faces of sheets 206. Overlapping the manufacturing sequence steps in this manner advantageously reduces overall manufacturing time.

### Enclosure Component Relationships and Assembly for Transport

FIG. 2 shows a top schematic view of finished structure 150 shown in FIG. 1, and includes a geometrical orthogonal grid for clarity of explaining the preferred dimensional relationships among its enclosure components 155. The basic length used for dimensioning is indicated as “E” in FIG. 2; the orthogonal grid overlaid in FIG. 2 is 8E long and 8E wide; notably, the entire structure 150 preferably is bounded by this 8E by 8E orthogonal grid.

Roof portions 400a, 400b and 400c each can be identically dimensioned in the transverse direction. Alternatively, referring to FIG. 3, roof portion 400c (which is stacked upon roof portions 400a and 400b when roof portions 400b, 400c are fully folded) can be dimensioned to be larger than either of roof portion 400a and roof portion 400b in the transverse direction for example, by ten to fifteen percent, or by at least the aggregate thickness of roof components 400a and 400b. This transverse direction dimensional increase is to reduce the chances of binding during the unfolding of roof portions 400b, 400c. In addition, as described in U.S. Nonprovisional patent application Ser. No. 16/786,315, entitled “Equipment and Methods for Erecting a Transportable Foldable Building Structure,” and filed on Feb. 10, 2020, friction-reducing components can be used to facilitate unfolding roof component 400, such as by positioning a first wheel caster at the leading edge of roof portion 400c proximate to the corner of roof portion 400c that is supported by wall portion 200s-2 as roof portion 400c is deployed, and positioning a second similar wheel caster at the leading edge of roof portion 400c proximate to the corner of roof portion 400c that is supported by wall portion 200s-4 as roof portion 400c is deployed. In such a case, roof portion 400c can be dimensioned larger than either of roof portions 400a and 400b in the transverse direction by at least the aggregate thickness of roof components 400a and 400b, less the length of the first or second wheel caster.

In FIG. 2, the four wall components 200 are each approximately 8E long, and each of roof portions 400a and 400b is approximately 8E long and 2.5E wide. Roof portion 400c is approximately 8E long and 2.9E wide. In FIGS. 2 and 3, each of floor components 300a and 300b is 8H long; whereas floor component 300a is just over 3E wide and floor component 300b is just under 5E wide.

The shipping module 100 shown edge-on in FIG. 3 includes a fixed space portion 102 defined by roof component 400a, floor component 300a, wall component 200R, wall portion 200s-1 and wall portion 200s-3. As shown in FIG. 2, second wall portion 200s-2 is folded inward and positioned generally against fixed space portion 102, and fourth wall portion 200s-4 is folded inward and positioned generally against second wall portion 200s-2 (wall portions 200s-2 and 200s-4 are respectively identified in FIG. 2 as portions 200s-2f and 200s-4f when so folded and positioned). The three roof components 400a, 400b and 400c are shown unfolded in FIG. 1 and shown accordion folded (stacked) in FIG. 3, with roof component 400b stacked on top of roof component 400a, and roof component 400c stacked on top of the roof component 400b. Wall component 200P, shown in FIGS. 2 and 3, is pivotally secured to floor portion 300b at the location of axis 105 (FIG. 3), and is vertically positioned against the outside of wall portions 200s-2 and 200s-4. In turn, floor portion 300b is vertically positioned proximate fixed space portion 102, with wall component 200P pending from floor portion 300b between floor portion 300b and wall portions 200s-2 and 200s-4.

Sizing the enclosure components 155 of structure 150 according to the dimensional relationships disclosed above yields a compact shipping module 100, as can be seen from the figures. Thus shipping module 100 depicted in FIG. 3, when dimensioned according to the relationships disclosed herein using an “E” dimension (see FIG. 2) of approximately 28.625 inches (72.7 cm), and when its components are stacked and positioned as shown in FIG. 3, has an overall length of approximately 19 feet (5.79 m), an overall width of approximately 8.5 feet (2.59 meters) and an overall height of approximately 12.7 feet (3.87 meters). These overall dimensions are less than a typical shipping container.

It is preferred that the fixed space portion 102 be in a relatively finished state prior to positioning (folding) together all of the other wall, roof and floor portions as described above. In the embodiment shown in FIGS. 1 and 2, wall components 200 are fitted during manufacture and prior to shipment with all necessary door and window assemblies, with the enclosure components 155 being pre-wired, and fixed space portion 102 is fitted during manufacture with all mechanical and other functionality that structure 150 will require, such as kitchens, bathrooms, closets and other interior partitions, storage areas, corridors, etc. Carrying out the foregoing steps prior to shipment permits the builder, in effect, to erect a largely finished structure simply by “unfolding” (deploying) the positioned components of shipping module 100.

Each of the wall, floor and roof components 200, 300 and 400, and/or the portions thereof, can be sheathed in protective film 177 during fabrication and prior to forming the shipping module 100. Alternatively or in addition, the entire shipping module 100 can be sheathed in a protective film. Such protective films can remain in place until after the shipping module 100 is at the construction site, and then removed as required to facilitate enclosure component deployment and finishing.

### Shipping Module Transport

The shipping module is shipped to the building site by appropriate transport means. One such transport means is disclosed in U.S. Pat. No. 11,007,921, issued May 18, 2021; the contents of which are incorporated by reference as if fully set forth herein, particularly as found at column 3, line 26 to column 6, line 25 and in FIGS. 1A-2D thereof. As an alternative transport means, shipping module 100 can be shipped to the building site by means of a conventional truck trailer or a low bed trailer (also referred to as a lowboy trailer), and in the case of over-the-water shipments, by ship.

### Structure Deployment and Finishing

At the building site, shipping module 100 is positioned over its desired location, such as over a prepared foundation; for example, a poured concrete slab, a poured concrete or cinder block foundation, sleeper beams or concrete posts or columns. This can be accomplished by using a crane, either to lift shipping module 100 from its transport and move it to the desired location, or by positioning the transport means over the desired location, lifting shipping module 100, then moving the transport means from the desired location, and then lowering shipping module 100 to a rest state at the desired location. Particularly suitable equipment and techniques for facilitating the positioning of a shipping module 100 at the desired location are disclosed in U.S. Nonprovisional patent application Ser. No. 16/786,315, entitled “Equipment and Methods for Erecting a Transportable Foldable Building Structure,” and filed on Feb. 10, 2020. The contents of that U.S. Nonprovisional patent application Ser. No. 16/786,315, entitled “Equipment and Methods for Erecting a Transportable Foldable Building Structure,” and filed on Feb. 10, 2020, are incorporated by reference as if fully set forth herein, particularly including the equipment and techniques described for example at ¶¶ 00126-00128 and in connection with FIGS. 11A and 11B thereof.

Following positioning of shipping module 100 at the building site, the appropriate portions of wall, floor and roof components 200, 300 and 400 are “unfolded” (i.e., deployed) to yield structure 150. Unfolding occurs in the following sequence: (1) floor portion 300b is pivotally rotated about horizontal axis 305 (shown in FIGS. 3 and 4) to an unfolded position, (2) wall component 200P is pivotally rotated about horizontal axis 105 (indicated in FIG. 3) to an unfolded position, (3) wall portions 200s-2 and 200s-4 are pivotally rotated about vertical axes 192 and 194 (shown in FIG. 2) respectively to unfolded positions, and (4) roof portions 400b and 400c are pivotally rotated about horizontal axes 405a and 405b (shown in FIGS. 3 and 4) respectively to unfolded positions. When accordion folded as a stack, it can be appreciated that the protective layer 218 of roof portion 400a is distal from the protective layer of roof portion 400b, whereas the protective layer 218 of roof portion 400b is in contact with, or proximate to, the protective layer of roof portion 400c. Thus in unfolding roof portions 400b and 400c, it is regarded herein that the protective layer 218 of the second component portion rotates toward the protective layer 218 of the first component portion 400a, whereas the protective layer 218 of the third component portion 400c rotates away from the protective layer 218 of the second component portion 400b.

A mobile crane can be used to assist in the deployment of certain of the enclosure components 155, specifically roof portions 400b and 400c, floor portion 300b, as well as the wall component 200P pivotally secured to floor portion 300b. Alternatively, particularly suitable equipment and techniques for facilitating the deployment of enclosure components 155 are disclosed in U.S. Nonprovisional patent application Ser. No. 16/786,315, entitled “Equipment and Methods for Erecting a Transportable Foldable Building Structure,” and filed on Feb. 10, 2020. The contents of that U.S. Nonprovisional patent application Ser. No. 16/786,315, entitled “Equipment and Methods for Erecting a Transportable Foldable Building Structure,” and filed on Feb. 10, 2020, are incorporated by reference as if fully set forth herein, particularly including the equipment and techniques described for example at ¶¶ 00132-00145 and depicted in FIGS. 12A-14B thereof.

After unfolding, the enclosure components 155 are secured together to finish the structure 150 that is shown in FIG. 1. If any temporary hinge structures have been utilized, then these temporary hinge structures can be removed if desired and the enclosure components 155 can be secured together. During or after unfolding and securing of the enclosure components 155, any remaining finishing operations are performed, such as addition of roofing material, and making hook-ups to electrical, fresh water and sewer lines to complete structure 150, as relevant here.

This disclosure should be understood to include (as illustrative and not limiting) the subject matter set forth in the following numbered clauses:

Clause 1. A fabrication facility for manufacturing a laminate multi-layer enclosure component comprising:

a press table;

a conveyor table adapted to move a plurality of superposed planar fabrication elements of a multi-layer enclosure component placed thereon into the press table;

a first rotatable turntable proximate to a first side of the conveyor table, and a second rotatable turntable proximate to an opposed second side of the conveyor table;

the first rotatable turntable adapted to have positioned thereon plural stacks of planar fabrication elements and to rotatably move each of such plural stacks to a first access position on the first rotatable turntable;

the second rotatable turntable adapted to have positioned thereon plural stacks of planar fabrication elements and to rotatably move each of such plural stacks to a second access position on the second rotatable turntable; and

a movable adhesive spray gantry straddling the conveyor table.

Clause 2. The fabrication facility as in clause 1, further comprising:

a first pair of opposed robotic assemblers straddling the conveyor table;

a first robotic assembler of the first pair of robotic assemblers adapted to move a top-most planar fabrication element from a first of the plural stacks of planar fabrication elements, positioned at the first access position, to the conveyor table; and

a second robotic assembler of the first pair of robotic assemblers adapted to move a top-most planar fabrication element from a first of the plural stacks of planar fabrication elements, positioned at the second access position, to the conveyor table.

Clause 3. The fabrication facility as in either of clause 1 or 2, further comprising:

a third rotatable turntable proximate to the first side of the conveyor table, and a fourth rotatable turntable proximate to the opposed second side of the conveyor table;

the third rotatable turntable adapted to have positioned thereon plural stacks of planar fabrication elements and to rotatably move each of such plural stacks to a third access position on the third rotatable turntable; and

the fourth rotatable turntable adapted to have positioned thereon plural stacks of planar fabrication elements and to rotatably move each of the plural stacks to a fourth access position proximate on the fourth rotatable turntable.

Clause 4. The fabrication facility as in clause 3, further comprising:

a second pair of opposed robotic assemblers straddling the conveyor table;

a third robotic assembler of the second pair of robotic assemblers adapted to move a top-most planar fabrication element from a first of the plural stacks of planar fabrication elements, positioned at the third access position, to the conveyor table; and

a fourth robotic assembler of the second pair of robotic assemblers adapted to move a top-most planar fabrication element from a first of the plural stacks of planar fabrication elements, positioned at the fourth access position, to the conveyor table.

Clause 5. The fabrication facility as in any one of clause 1, 2, 3 or 4, wherein the first robotic assembler is adapted to move a top-most planar fabrication element from a second of the plural stacks of planar fabrication elements, positioned at the first access position adjacent to the first of the plural stacks of planar fabrication elements, from the second of the plural stacks to the conveyor table, and the second robotic assembler is adapted to move a top-most planar fabrication element from a second of the plural stacks of planar fabrication elements, positioned at the second access position adjacent to the first of the plural stacks of planar fabrication elements, from the second of the plural stacks to the conveyor table.

Clause 6. The fabrication facility as in either of clause 4 or 5, wherein the third robotic assembler is adapted to move a top-most planar fabrication element from a second of the plural stacks of planar fabrication elements, positioned at the third access position adjacent to the first of the plural stacks of planar fabrication elements positioned at the third access position, from the second of the plural stacks to the conveyor table, and the second robotic assembler is adapted to move a top-most planar fabrication element from a second of the plural stacks of planar fabrication elements, positioned at the fourth access position adjacent to the first of the plural stacks of planar fabrication elements positioned at the fourth access position, from the second of the plural stacks to the conveyor table.

Clause 7. The fabrication facility as in any one of clauses 1-6, wherein at least one mixed stack comprising one or more foam panels and one or more metal sheets is positioned at the first access position on the first rotatable turntable.

Clause 8. The fabrication facility as in any one of clauses 1-6, wherein at least one mixed stack comprising a foam panel and a metal sheet of a different size than the foam panel is positioned at the first access position on the first rotatable turntable.

Clause 9. The fabrication facility as in any one of clauses 1-6, wherein at least one mixed stack comprising a foam panel overlying or underlying two adjacent metal sheets is positioned at the first access position on the first rotatable turntable.

Clause 10. The fabrication facility as in clause 1-9, wherein the first rotatable turntable has positioned thereon only plural stacks of planar fabrication elements each of which does not include any door or window apertures, and the second rotatable turntable has positioned thereon only plural stacks of planar fabrication elements each of which does include a door or window aperture.

Clause 11. A method of manufacturing an enclosure component having a laminate multi-layer design utilizing a conveyor table and one or more rotatable turntables, each adapted to have positioned thereon, and each having positioned thereon, plural stacks of planar fabrication elements, each of the one or more rotatable turntables further adapted to rotatably move each of the plural stacks positioned thereon to an access position proximate to the conveyor table, comprising:

moving to the conveyor table a planar first fabrication element from a first of the plural stacks of planar fabrication elements located at the access position on the first rotatable turntable;

rotating the first rotatable turntable, to position at the access position of the first rotatable turntable a second of the plural stacks of planar fabrication elements positioned on the first rotatable turntable; and

moving to the conveyor table a planar second fabrication element from the second of the plural stacks of planar fabrication elements positioned at the access position of the first rotatable turntable.

Clause 12. The method as in clause 11, further comprising, between the steps of (i) moving to the conveyor table a planar first fabrication element and (ii) rotating the first rotatable turntable:

moving to the conveyor table a planar third fabrication element from a third of the plural stacks of planar fabrication elements located at the access position of the first rotatable turntable.

Clause 13. The method as in either of clause 11 or 12, wherein the first fabrication element is a metal sheet.

Clause 14. The method as in either of clause 12 or 13, wherein the third fabrication element is a metal sheet.

Clause 15. The method as in either of clause 12 or 13, wherein the third fabrication element is a foam panel.

Clause 16. The method as in clause 15, comprising the step of spraying adhesive on the first fabrication element prior to moving the foam panel, and wherein the foam panel is moved to the conveyor table superposed on the first fabrication element.

Clause 17. The method as in either of clause 11 or 12, further comprising, between the steps of (i) moving to the conveyor table a planar first fabrication element and (ii) rotating the first rotatable turntable:

moving to the conveyor table a planar fourth fabrication element from a fourth of the plural stacks of planar fabrication elements located at the access position of a second rotatable turntable.

Clause 18. The method as in clause 17, wherein the fourth fabrication element defines an aperture for a door or window.

Clause 19. A method of manufacturing an enclosure component having a laminate multi-layer design comprising:

positioning a first metal sheet on the conveyor table;

positioning a second metal sheet on the conveyor table adjacent the first metal sheet to form a first structural layer having a first face on the conveyor table and/ an opposing second face;

applying an adhesive to the opposing second face of the first structural layer;

positioning a first foam panel on the opposing second face of the first structural layer;

positioning a second foam panel on the opposing second face of the first structural layer adjacent the first foam panel to form a foam panel layer having a first face on the first structural layer and an opposing second face;

applying an adhesive to the opposing second face of the foam panel layer;

positioning a third metal sheet on the opposing second face of the foam panel layer;

positioning a fourth metal sheet on the opposing second face of the foam panel layer adjacent the third metal sheet to form a second structural layer having a first face on the foam panel layer and an opposing second face;

applying an adhesive to the opposing second face of the second structural layer;

positioning a first protective panel having an inorganic composition on the opposing second face of the second structural layer;

positioning a second protective panel having an inorganic composition on the opposing second face of the second structural layer to form a protective layer, and further to form a laminate assembly comprising the first structural layer, the first foam panel layer, the second structural layer and the protective layer in a superposed relationship; and

applying pressure to the laminate assembly to bond together the first structural layer, the foam panel layer, the second structural layer and the protective layer.

Clause 20. The method of manufacturing as in clause 19, wherein one or more of the first, second, third and fourth metal sheets are galvanized steel.

Clause 21. The method of manufacturing as in clause 20, wherein each of the first, second, third and fourth metal sheets is galvanized steel.

Clause 22. The method of manufacturing as in any one of clause 19, 20 or 21, wherein the first and second foam panels are each expanded polystyrene foam.

Clause 23. The method of manufacturing as in any one of clause 19, 20, 21 or 22, wherein the first and second protective panels are each magnesium oxide board.

Clause 24. The method of manufacturing as in any one of clause 19, 20, 21, 22 or 23, wherein the step of applying pressure is performed in a vacuum press.

Clause 25. The method of manufacturing as in any one of clauses 19-24, wherein each of the first foam panel, the first protective panel, the first metal sheet and the third metal sheet defines a door or window aperture.

Clause 26. A planar enclosure component for a building structure comprising: a first structural layer having a first face, an opposing second face and comprising a first metal sheet arranged in a side-by-side relationship with a second metal sheet;

a foam panel layer having a first face, an opposing second face and comprising a first foam panel arranged in a side-by-side relationship with a second foam panel, the first face of the foam panel layer being bonded to the opposing second face of the first structural layer;

a second structural layer having a first face, an opposing second face and comprising a third generally rectangular metal sheet arranged in a side-by-side relationship with a fourth metal sheet, the first face of the second structural layer being bonded to the opposing second face of the foam panel layer; and

a protective layer having a first face, an opposing second face and comprising a first generally rectangular protective panel having an inorganic composition arranged in a side-by-side relationship with a rectangular protective panel having an inorganic composition, the first face of the protective layer being bonded to the opposing second face of the second structural layer.

Clause 27. The planar enclosure component as in clause 26, wherein one or more of the first, second, third and fourth metal sheets are galvanized steel.

Clause 28. The planar enclosure component as in clause 27, wherein each of the first, second, third and fourth metal sheets is galvanized steel.

Clause 29. The planar enclosure component as in any one of clause 26, 27 or 28, wherein the first and second foam panels are each expanded polystyrene foam.

Clause 30. The planar enclosure component as in any one of clause 26, 27, 28 or 29, wherein the first and second protective panels are each magnesium oxide board.

What is claimed is:

1. A fabrication facility for manufacturing a laminate multi-layer enclosure component comprising:
a press table;
a conveyor table adapted to move a plurality of superposed planar fabrication elements of a multi-layer enclosure component placed thereon into the press table;
a first rotatable turntable proximate to a first side of the conveyor table, and a second rotatable turntable proximate to an opposed second side of the conveyor table;
the first rotatable turntable adapted to have positioned thereon plural stacks of planar fabrication elements and to rotatably move each of such plural stacks to a first access position on the first rotatable turntable;
the second rotatable turntable adapted to have positioned thereon plural stacks of planar fabrication elements and to rotatably move each of such plural stacks to a second access position on the second rotatable turntable; and
a movable adhesive spray gantry straddling the conveyor table.

2. The fabrication facility as in claim 1, further comprising:
a first pair of opposed robotic assemblers straddling the conveyor table;
a first robotic assembler of the first pair of robotic assemblers adapted to move a top-most planar fabrication element from a first of the plural stacks of planar fabrication elements, positioned at the first access position, to the conveyor table; and
a second robotic assembler of the first pair of robotic assemblers adapted to move a top-most planar fabrication element from a first of the plural stacks of planar fabrication elements, positioned at the second access position, to the conveyor table.

3. The fabrication facility as in claim 1, further comprising:
a third rotatable turntable proximate to the first side of the conveyor table, and a fourth rotatable turntable proximate to the opposed second side of the conveyor table;
the third rotatable turntable adapted to have positioned thereon plural stacks of planar fabrication elements and to rotatably move each of such plural stacks to a third access position on the third rotatable turntable; and
the fourth rotatable turntable adapted to have positioned thereon plural stacks of planar fabrication elements and to rotatably move each of the plural stacks to a fourth access position on the fourth rotatable turntable.

4. The fabrication facility as in claim 3, further comprising:
a second pair of opposed robotic assemblers straddling the conveyor table;
a third robotic assembler of the second pair of robotic assemblers adapted to move a top-most planar fabrication element from a first of the plural stacks of planar fabrication elements, positioned at the third access position, to the conveyor table; and
a fourth robotic assembler of the second pair of robotic assemblers adapted to move a top-most planar fabrication element from a first of the plural stacks of planar fabrication elements, positioned at the fourth access position, to the conveyor table.

5. The fabrication facility as in claim 1, wherein the first robotic assembler is adapted to move a top-most planar fabrication element from a second of the plural stacks of planar fabrication elements, positioned at the first access position adjacent to the first of the plural stacks of planar fabrication elements, from the second of the plural stacks to the conveyor table, and the second robotic assembler is adapted to move a top-most planar fabrication element from a second of the plural stacks of planar fabrication elements, positioned at the second access position adjacent to the first of the plural stacks of planar fabrication elements, from the second of the plural stacks to the conveyor table.

6. The fabrication facility as in claim 4, wherein the third robotic assembler is adapted to move a top-most planar fabrication element from a second of the plural stacks of planar fabrication elements, positioned at the third access position adjacent to the first of the plural stacks of planar fabrication elements positioned at the third access position, from the second of the plural stacks to the conveyor table, and the second robotic assembler is adapted to move a top-most planar fabrication element from a second of the plural stacks of planar fabrication elements, positioned at the fourth access position adjacent to the first of the plural stacks of planar fabrication elements positioned at the fourth access position, from the second of the plural stacks to the conveyor table.

7. The fabrication facility as in claim 1, wherein at least one mixed stack comprising one or more foam panels and one or more metal sheets is positioned at the first access position on the first rotatable turntable.

8. The fabrication facility as in claim 1, wherein at least one mixed stack comprising a foam panel and a metal sheet of a different size than the foam panel is positioned at the first access position on the first rotatable turntable.

9. The fabrication facility as in claim 1, wherein at least one mixed stack comprising a foam panel overlying or underlying two adjacent metal sheets is positioned at the first access position on the first rotatable turntable.

10. The fabrication facility as in claim 1, wherein the first rotatable turntable has positioned thereon only plural stacks of planar fabrication elements each of which does not include any door or window apertures, and the second rotatable turntable has positioned thereon only plural stacks of planar fabrication elements each of which does include a door or window aperture.

11. A method of manufacturing an enclosure component having a laminate multi-layer design utilizing a conveyor table and one or more rotatable turntables, each adapted to have positioned thereon, and each having positioned thereon, plural stacks of planar fabrication elements, each of the one or more rotatable turntables further adapted to rotatably move each of the plural stacks positioned thereon to an access position proximate to the conveyor table, comprising:
moving to the conveyor table a planar first fabrication element from a first of the plural stacks of planar fabrication elements located at the access position on the first rotatable turntable;
rotating the first rotatable turntable, to position at the access position of the first rotatable turntable a second of the plural stacks of planar fabrication elements positioned on the first rotatable turntable; and
moving to the conveyor table a planar second fabrication element from the second of the plural stacks of planar fabrication elements positioned at the access position of the first rotatable turntable.

12. The method as in claim 11, further comprising, between the steps of (i) moving to the conveyor table a planar first fabrication element and (ii) rotating the first rotatable turntable:
moving to the conveyor table a planar third fabrication element from a third of the plural stacks of planar fabrication elements located at the access position of the first rotatable turntable.

13. The method as in claim 11, wherein the first fabrication element is a metal sheet.

14. The method as in claim 12, wherein the third fabrication element is a metal sheet.

15. The method as in claim 12, wherein the third fabrication element is a foam panel.

16. The method as in claim 15, comprising the step of spraying adhesive on the first fabrication element prior to moving the foam panel, and wherein the foam panel is moved to the conveyor table superposed on the first fabrication element.

17. The method as in claim 11, further comprising, between the steps of (i) moving to the conveyor table a planar first fabrication element and (ii) rotating the first rotatable turntable:
moving to the conveyor table a planar fourth fabrication element from a fourth of the plural stacks of planar fabrication elements located at the access position of a second rotatable turntable.

18. The method as in claim 17, wherein the fourth fabrication element defines an aperture for a door or window.

19. A method of manufacturing an enclosure component having a laminate multi-layer design comprising:
positioning a first metal sheet on the conveyor table;
positioning a second metal sheet on the conveyor table adjacent the first metal sheet to form a first structural layer having a first face on the conveyor table and/ an opposing second face;
applying an adhesive to the opposing second face of the first structural layer;
positioning a first foam panel on the opposing second face of the first structural layer;
positioning a second foam panel on the opposing second face of the first structural layer adjacent the first foam panel to form a foam panel layer having a first face on the first structural layer and an opposing second face;
applying an adhesive to the opposing second face of the foam panel layer;
positioning a third metal sheet on the opposing second face of the foam panel layer;
positioning a fourth metal sheet on the opposing second face of the foam panel layer adjacent the third metal sheet to form a second structural layer having a first face on the foam panel layer and an opposing second face;
applying an adhesive to the opposing second face of the second structural layer;
positioning a first protective panel having an inorganic composition on the opposing second face of the second structural layer;
positioning a second protective panel having an inorganic composition on the opposing second face of the second structural layer to form a protective layer, and further to form a laminate assembly comprising the first structural layer, the first foam panel layer, the second structural layer and the protective layer in a superposed relationship; and
applying pressure to the laminate assembly to bond together the first structural layer, the foam panel layer, the second structural layer and the protective layer.

20. The method of manufacturing as in claim 19, wherein one or more of the first, second, third and fourth metal sheets are galvanized steel.

21. The method of manufacturing as in claim 20, wherein each of the first, second, third and fourth metal sheets is galvanized steel.

22. The method of manufacturing as in claim 19, wherein the first and second foam panels are each expanded polystyrene foam.

23. The method of manufacturing as in claim 19, wherein the first and second protective panels are each magnesium oxide board.

24. The method of manufacturing as in claim 19, wherein the step of applying pressure is performed in a vacuum press.

25. The method of manufacturing as in claim 19, wherein each of the first foam panel, the first protective panel, the first metal sheet and the third metal sheet defines a door or window aperture.

26. A planar enclosure component for a building structure comprising:
a first structural layer having a first face, an opposing second face and comprising a first metal sheet arranged in a side-by-side relationship with a second metal sheet;
a foam panel layer having a first face, an opposing second face and comprising a first foam panel arranged in a side-by-side relationship with a second foam panel, the first face of the foam panel layer being bonded to the opposing second face of the first structural layer;
a second structural layer having a first face, an opposing second face and comprising a third generally rectangular metal sheet arranged in a side-by-side relationship with a fourth metal sheet, the first face of the second structural layer being bonded to the opposing second face of the foam panel layer; and
a protective layer having a first face, an opposing second face and comprising a first generally rectangular protective panel having an inorganic composition arranged in a side-by-side relationship with a rectangular protective panel having an inorganic composition, the first face of the protective layer being bonded to the opposing second face of the second structural layer.

27. The planar enclosure component as in claim 26, wherein one or more of the first, second, third and fourth metal sheets are galvanized steel.

28. The planar enclosure component as in claim 27, wherein each of the first, second, third and fourth metal sheets is galvanized steel.

29. The planar enclosure component as in claim 26, wherein the first and second foam panels are each expanded polystyrene foam.

30. The planar enclosure component as in claim 26, wherein the first and second protective panels are each magnesium oxide board.
